(19) United States
(12) Patent Application Publication
(10) Pub. No.: US 2009/0107200 A1
(43) Pub. Date: Apr. 30, 2009

(54) METHOD FOR MAKING HANDTOOL HEAD AND A ROLLING MILL THEREOF

(76) Inventor: Shusen Luo, Shandong (CN)

Correspondence Address: SEED INTELLECTUAL PROPERTY LAW GROUP PLLC, 701 FIFTH AVE, SUITE 5400, SEATTLE, WA, 98104, US

(21) Appl. No.: 11/996,282

(22) PCT Filed: Jul. 18, 2006
(86) PCT No.: PCT/CN2006/001735

§ 371 Date: Dec. 15, 2008

(30) Foreign Application Priority Data
Jul. 18, 2005 (CN) 200520113951.6

(51) Int. Cl. B21B 31/32; B23P 17/04

(52) U.S. Cl. 72/245; 29/592

(57) ABSTRACT

A method for manufacturing a hand-tool head involves rolling an elongate blank comprising many hand-tool heads which are connected head-end T by head-end T and tail-end W by tail-end W, then cutting off the blank with length of the hand-tool head, thereby forming hand-tool heads. A rolling mill for continuously rolling the hand-tool head includes an upper roller and a lower roller on each of which a ring-shape cavity is provided respectively. Both rollers are provided with a driving gear and a driven gear. When the rollers are to be driven, they are driven to rotate in opposite directions at a same speed by the gears. A plate billet is drawn into a mould cavity consisting of the two ring-shape cavities by the two ring-shape cavities after feeding in via an inlet of the rolling mill, so as to produce an elongate blank comprising many hand-tool head connected head-end by head-end at an outlet of the rolling mill.

### TECHNICAL FIELD

This invention relates to a dedicated rolling mill, and more particularly, to a dedicated rolling mill for continuously rolling an irregularly shaped section, such as an axe head or hammer head. The invention further relates to a hand-tool head manufacturing method, more particularly, to a manufacturing method for producing the hand-tool head by use of a continuous rolling technology, and also relates to a rolling mill for continuously rolling the hand-tool head.

### BACKGROUND ART

A conventional axe head or hammer head is manufactured and shaped by use of a die-forging method, but by use of that manufacture solution, a rod material of high quality steel is required, cut into sections in accordance with the material amount required by the forging die, heated in a furnace, and individually taken out of the furnace and put into the forging die to be die-forged and shaped when a worker performs forage, and the axe head or hammer head produced by use of that technology solution not only uses an expensive rod material of high quality steel, but also its material utilization ratio is only about 70%; further, when that technology solution is used to produce an axe head or hammer head, only one axe head or hammer head can be produced and formed one time, its manufacture efficiency is low, and there are a heavy labor intensity required for the operation and production, a high energy consumption, and a high price of material, so that the production cost of the present product is further caused to be high and can not be reduced.

A rolling technology is an advanced technology for forming a part, and has been widely used in techniques for manufacturing and forming equal section parts. There has been a practice that the rolling technology is used to produce equal section billet similar to the side surface shape of a hammer or the like, then the billet is cut off at its side surface as semi-finished product, and a forage technology is used to produce the hammer or the like, but the products of hammer or the like have standards in various countries, such as DIN (Germany), US (The United States), BS (Britain), NF (France), and GB (China), which standards have strict requirements for shapes and dimensions of the longitudinal section and cross section, corner chamfering, edge chamfering, arcs, marks, shapes and dimensions of hammer hole, as well as the relative positions and dimensions of those sections, and at same time have strict requirements for the product quality and product weight, so that there must be accurate position correspondences between the longitudinal section and cross section of various cavities on every roller, between cavities on every roller, and between the corresponding cavities of two rollers, and the corresponding errors of two cavities at any position of the whole circumference of a roller, after taking the errors accumulated in various chains into consideration, can not exceed 0.5 mm, i.e. requiring that when two rollers of diameters of 500 mm are in rolling operation under large load the maximum value of the transmission errors of the cavities on two rollers at any angle can not exceed 0.09 degree, or otherwise, the cavities of roller sections can not produce qualified hand-tool head blank member, in the present general machining technology, since a gear and a cavity are machined by two kind of different machining apparatuses and different machining methods, if two forming rollers are positioned longitudinally along their circumference directions using gears the rollers with cavities and the gears formed by machining must be assembled into forming rollers, and when a rolling mill assembled by such upper roller and lower roller is used to perform rolling operation, the following 5 kind of errors would occur in the corresponding accuracy of the cavities:

1. The upper roller drive the lower roller to rotate through gears, the absolute values of the rotary angles of two rollers are not completely same, and the actual values of the input rotary angle of the upper roller and the output rotary angle of the lower roller have a change quantity with respect to the theory values, therefore the corresponding positions of the cavities of two rollers would generate an alternation error curve shown in FIG. 6.

2. When straight tooth gear transmission is used, two gears, when their meshed teeth are changed, have a changing instant transmission ratio and an impact, so as to cause the cavities on two rollers at that time to create corresponding errors when rolling.

3. There are dimension accuracy errors and position accuracy errors of various tool head cavities on annular cavities of hand-tool head blank member group on each roller.

4. There are indexing and positioning errors of various tool head cavities of annular cavities of two rollers.

5. There are errors due to the assembly of gears with cavities on the rollers.

The accumulated error, which has a strong randomness and is accumulated by at least five kind of errors above, are created at the time of corresponding rolling of the cavities of two rollers after the upper and lower rollers are assembled into a rolling mill, and according to the technical standard requirements of hand-tool heads, the corresponding errors of the cavities of various sections of circumferences of two rollers can not exceed 0.09 degree, or otherwise, the cavities of two rollers can not produce qualified hand-tool head blank member group, but that accumulated error is difficult to be controlled by use of the present general manufacture technology, therefore all the shapes and dimensions of those various sections attempted to be accurately formed by using conventional technology through rolling have large variations, and it is a difficult event to manufacture a hand-tool head having strict requirements for relative positions of the various sections in lateral direction and requiring a good surface forming quality, although there has been a rolling mill in which rollers are provided with a driving gear and a driven gear and one roller drives the other roller through the gears, this rolling mill has only eliminated a three-axis box to simplify the rolling mill transmission system but fails to produce a hand-tool head requiring high positioning accuracy by using continuous rolling method. The present roll-forging technology can use arc-shaped die to forge a hand-tool head, but an accompanying process for making billet must be used and only one work piece can be roll-forged each time, so that the forged member must have periphery flashes in order to be well formed, and there are not only a heavy raw material consumption but also a low production efficiency.

The end surfaces hand-tool head produced by a conventional manufacture method have flashes, and slopes for mould-parting, the end surfaces must be heated to make heat treatments after being machined, and till now there has not been the actual practice that the end surfaces of the hand-tool head are directly quenched by using the residual heat of rolling after being machined above the quenching temperature Ac₁ . . . Ac₄.

The prior art has not yet disclosed a rolling mill capable of online adjusting upper and lower rollers to align moulds, and when mould misalignment occurs in the rolled products, adjustment can not be made on the production line.

### SUMMARY OF THE INVENTION

An object of the invention is to overcome the defects in the prior art, and to provide an new technology for continuously rolling hand-tool heads, and the blank rolled by using this rolling technology is constituted by hand-tool heads, the ends of which are joined together.

For this purpose, the technical solution of the invention is as follows:

A hand-tool head manufacturing method is characterized by that a blank constituted by end-joined hand-tool head blank members is rolled out by using a rolling mill, and is cut off according to the length of the hand-tool head to form hand-tool heads.

The advantages of the hand-tool head manufacturing method proposed by the invention are:

1. Since the sectional areas of the ends of the hand-tool head are much less than those of its side surfaces, and the profiles of the ends are regular shapes, such as a circle, a square, or a regular rhombus, with end surfaces being planar, the blank thus arranged by end-joining are cut off at the joining place to form hand-tool heads by using saw-cutting and high-accuracy punching and trimming technologies, with the cut-off surfaces becoming work surfaces with a high plainness and smooth finish without machining, and since the side surfaces of the hand-tool heads have been completely formed in the cavities, the hand-tool heads manufactured by this method become the hand-tool heads which conform to standard dimensions.

2. The heat cut-off end surfaces of the hand-tool heads make it possible that the quenching treatment on the hitting work surfaces can be performed by directly using the residual rolling heat.

3. The continuous rotation of the rolling mill without interruption can roll out an elongate blank constituted by the joined hand-tool heads.

The hand-tool head blank members forming the blank have different sectional shapes.

The blank is an arrangement in a head-end to head-end joined and tail-end to tail-end joined manner of the hand-tool heads whose head-ends and tail-ends are different.

Corresponding to one rolling turn of an upper roller and a lower roller of the rolling mill, a hand-tool head blank member group joined by ends of an integral number of hand-tool heads can be rolled.

In this hand-tool head manufacturing method proposed by the invention, on two rollers of the rolling mill there are respectively made with annular-shape cavities, which have corresponding positions and are joined in head-end to head-end and tail-end to tail-end, so that although section shapes of the head-ends and tail-ends of hand-tool heads are different and the section areas have several times of differences, such arrangement can make the section shapes and areas at adjacent cavities be same, and the advantages are:

1. The difficulty of the cavity manufacture is reduced.

2. Although the sections of both head-end and tail end of every hand-tool head are quite different, the cavity join place of that design is smooth, the rolled blank can be released from the mould smoothly, the strong impact of the flowing metal on the head to tail joined place of the cavity upon rolling formation can be eliminated, the blank with such great variation in section can be rolled using rollers of general material quality, and the use life of the cavity is improved.

3. When rolling is performed by using thus arranged cavities, the compressed process of the billet in the cavities becomes a relatively smooth process, so as to make the rolling formation of hand-tool heads good.

The rolling mill is used to roll out the blank constituted by end-joined hand-tool heads which can be finally completed only after the fitting-holes are machined, the blank is cut off into hand-tool heads, and the fitting-holes of the hand-tool heads are machined, thereby reducing the difficulty of the rolling formation and making rolling technology able to be used in the manufacture and formation of hand-tool heads.

After a part of metal is first removed from the fitting-holes of the hand-tool heads by drilling method, the fitting-holes are punched by a punch head so as to realize the cold processing of the fitting-holes.

The rolling mill is used to roll out the blank constituted by the end-joined hand-tool head blank members in which the locations of the fitting-holes are provided with technique indentations, the blank is cut off in accordance with the length of the hand-tool head, and the cut-off hand-tool head blank members are punched at the locations of the fitting-holes to form the fitting-holes.

In this hand-tool head manufacturing method proposed by the invention, for hand-tools such as hammers, the rolling mill is first used to roll out the blank constituted by the end-joined hand-tool heads in which the positions of handle-fitting ends of the fitting-holes are provided with technique indentations of sunken-hole type which have sectional shapes same as those of the fitting-holes, and after being cut off, the hand-tool heads are processed to form the handle-fitting holes along the technique indentations at the fitting-holes by using a hole-punching technology, and for hand-tool heads such as axes, pickaxes, etc., in which the rolling and stretching direction is not consistent with that of the handle-fitting hole, the rolling mill is first used to roll out the blank constituted by the hand-tool head bland members in which on both sides of the fitting-hole position there are provided technique indentations, and after being cut off, the hand-tool heads are punched to form the fitting-holes by using a hole-punching technology, making the technique indentations become flush with the surfaces of the hand-tool heads due to the outward expanding action of the punch head upon punching, thus after the hole-punching there is no need for trimming their profiles so as to simplify the technique and to improve the production efficiency.

A billet is heated, the rolling mill is used to roll the billet into the blank constituted by the end-joined hand-tool head blank members, and the heat-rolled blank is heat-treated using the residual rolling heat, thereby reducing the production cost.

The billet is heated, the rolling mill is used to roll the heated billet into the blank constituted by the end-joined hand-tool head blank members, and after the blank is cut off, the hand-tool head blank members are heat-treated using the residual rolling heat.

The ends of the hand-tool head blank members are quenched using the residual rolling heat.

The heat-rolled blank is cut off at the joined ends of the hand-tool head blank members using a saw machine, which is provided with several saw-blades at the interval of length of the hand-tool heads.

This hand-tool head manufacturing method proposed by the invention has the following active effects:

(1) The blank in a red heat state above 800° C. can be sawed off efficiently at high speed, i.e. sawed off once in 1 to 2 second, and the power consumption is low.

(2) The blank can be heat-sawed by a saw machine provided with a plurality of groups of saw-blades so as to be dissected into a plurality of hand-tool heads in once saw advancement, and the dissected surfaces become the work surfaces with neither rough machining nor rolling milling sequence, thereby improving the efficiency.

(3) The flow-line operations of roll-forming and cutting-off can be realized.

(4) After the ends have been cut-off, their dissected surfaces are smooth and without oxidized skins, and the quench quality is high.

(5) The heat-treatment does not need a second heating.

(6) The technique is a deformed heat-treatment and can achieve a comprehensive effect of deformation strengthening and phase-change strengthening, and the mechanical characteristics of the hand-tool heads are substantially enhanced.

There is provided with a conventional rolling mill upstream said rolling mill, in operation of the hand-tool head manufacturing method of the invention, according to the dimension variations of the blank to be rolled, at first a raw billet is initially rolled into a billet, and after the initial rolling being completed, when the profile size of the material is close to and consistent with that of the hand-tool head, the rolling mill is used to perform the fine rolling at the last stage, so that the blank of the hand-tool head can be directly rolled out from metallurgical raw billet by using once heating.

There is provided with a crystallizer upstream said rolling mill, and the hand-tool head manufacturing method proposed by the invention realizes continuous casting and continuous rolling of the hand-tool heads.

The whole blank is continuously grinded and polished, and then is cut off in the length of the hand-tool heads to form them, thereby realizing the automatic and continuous grinding and polishing of the hand-tool heads.

Said hand-tool heads are the hand-tool heads in form of a circular head hammer, an axe, an octagonal hammer, a masons hammer, a bench-work hammer, etc.

The invention further provides a rolling mill for continuously rolling hand-tool heads that comprises a rolling mill frame (12), an upper roller (5, 105, 205, 505) and a lower roller (7, 107, 207, 507), on the roller surfaces of both the upper roller (5, 105, 205, 505) and the lower roller (7, 107, 207, 507) being manufactured with concave cavities, characterized by that the concave cavities on the roller surfaces of both the upper roller (5, 105, 205, 505) and the lower roller (7, 107, 207, 507) are concave annular cavities (16) and (17), and that the shapes of said concave annular cavities (16, 17) correspond to that of a hand-tool head blank member group (29, 129, 229, 329, 529) constituted by an integral number of end-joined hand-tool head blank members (27, 127, 227, 327, 527).

Preferably, the shapes of said concave annular cavities (16, 17) correspond to those of the hand-tool head blank member group (29, 129, 229, 329, 529) constituted by an integral number of head-end (T) to head-end (T) joined and tail-end (W) to tail-end (W) joined hand-tool head blank members (27, 127, 227, 327, 527).

Preferably, said concave annular cavities (16, 17) are formed in following manner: designing a parting surface (A₁A₃) of the hand-tool head blank member group (29, 129, 229, 329, 529) in the manner of joining an integral number of hand-tool head blank members (27, 127, 227, 327, 527) head-end (T) to head-end (T) and tail-end (W) to tail-end (W), and forming the annular concave cavity (16) along the roller surface of the upper roller (5, 105, 205, 505) in accordance with the shape of a portion of the hand-tool head blank member group (29, 129, 229, 329, 529) on the upper side, i.e. the (N) side, of the parting surface (A₁A₃), and forming the annular concave cavity 17 along the roller surface of the lower roller (7, 107, 207, 507) in accordance with the shape of a portion of the hand-tool head blank member group (29, 129, 229, 329, 529) on the lower side, i.e. the (S) side, of the parting surface (A₁A₃).

Preferably, the upper roller (5, 105, 205, 505) and the lower roller (7, 107, 207, 507) are equipped with a driving gear (1, 501) and a driven gear (8, 508), are mounted to the rolling mill frame (12), and are rotatable in opposite directions while the positions correspond, and when the driving gear (1, 501) and the driven gear (8, 508) are drived, the annular cavity (16) and the annular cavity (17) correspond to each other to combine into a cavity (19) whose sectional shape is same as that of the hand-tool head blank member group (29, 129, 229, 329, 529) at the corresponding position.

Preferably, forming said concave annular cavities further includes: several cross sections (B₀, B₁, B₂, B₃, . . . Bₙ₋₁, Bₙ) perpendicular to the parting surface (A₁A₃) are formed starting from one end of the hand-tool head blank member group (29, 129, 229, 329, 529), several cross sections (1B₀, 1B₁, 1B₂, 1B₃, . . . 1Bₙ₋₁, 1Bₙ) and (2B₀, 2B₁, 2B₂, 2B₃, . . . 2Bₙ₋₁, 2Bₙ) perpendicular to the parting surfaces (1A₁1A₃) and (2A₁2A₃) are respectively formed, from intersecting positions of the sections (B₀, B₁, B₂, B₃, . . . Bₙ₋₁, Bₙ) with the parting surface (A₁A₃), on the hand-tool head portion on the upper side, i.e. the (N) side, of the parting surface and the hand-tool head portion on the lower side, i.e. the (S) side, of the parting surface, the parting surface (1A₁A₃) of the hand-tool heads on the (N) side is bent, in a manner making the parting surface be outside, into a circle (1A₁A₃′) in which (1B₀) coincides with (1Bₙ) and which coincides with the outside circle of the cavity part of the upper roller (5), and it is made that the various sections (1B₀, 1B₁, 1B₂, 1B₃, . . . 1Bₙ₋₁, 1Bₙ) each lie respectively within a plane which is formed by the roller surface generatrix of the upper roller (5, 105, 205, 505) and the axis (O₁O₁′) of the upper roller (5, 105, 205, 505), those sections become several sections (1B₀′, 1B₁′, 1B₂′, 1B₃′, . . . 1Bₙ₋₁′, 1Bₙ′) which use the axis (O₁O₁′) of the upper roller (5, 105, 205, 505) as the intersection line and the roller surface generatrix of the upper roller (5, 105, 205, 505) as their outside and between every two of which an included angle is formed, the various sections (1B₀′, 1B₁′, 1B₂′, 1B₃′, . . . 1Bₙ₋₁′, 1Bₙ′) form the annular cavity (16) part of the upper roller (5, 105, 205, 505), the parting surface (2A₁A₃) of the hand-tool heads on the (S) side is bent on the lower roller (7, 107, 207, 507), in a direction opposite to that of the parting surface (1A₁A₃′) on the upper roller (5, 105, 205, 505) and in a manner making the parting surface be outside, into a circle (2A₁2A₃′) in which (2B₀) coincides with (2Bₙ), and it is made that the various sections (2B₀, 2B₁, 2B₂, 2B₃, . . . 2Bₙ₋₁, 2Bₙ) each lie respectively within a plane which is formed by the roller surface generatrix of the lower roller (7, 107, 207, 507) and the axis (O₂O₂′) of the lower roller (7, 107, 207, 507), those sections become several sections (2B₀′, 2B₁′, 2B₂′, 2B₃′, . . . 2Bₙ₋₁′, 2Bₙ′) which use the axis (O₂O₂′) of the lower roller (7, 107, 207, 507) as the intersection line and the roller surface generatrix of the lower roller (7, 107, 207, 507) as their outside and are arranged in a direction opposite to that from (1B₀′, 1B₁′, 1B₂′, 1B₃′, . . . to 1Bₙ₋₁′, 1Bₙ′) on the upper roller (5, 105, 205, 505) and between every two of which an included angle is formed, the various sections (2B₀′, 2B₁′, 2B₂′, 2B₃′, . . . 2Bₙ₋₁, 2Bₙ′) form the annular cavity (17) part of the lower roller (7, 107, 207, 507), characterized further by that, when the upper roller (5, 105, 205, 505) and the lower roller (7, 107, 207, 507) on a rolling mill (26, 126, 226, 526) are rotated in opposite directions at corresponding positions to perform rolling formation, i.e. a billet (9, 109, 209, 309, 509) fed through a rolling-in end is continuously squeezed into a cavity (19) combined by both the cavity (16) and the cavity (17), when the section (1B₀′) on the upper roller (5,105,205, 505) lies within a plane (O₁O₁′O₂O₂′) formed by axes (O₁O₁′) and (O₂O₂′) of both rollers, (2B₀′) also lies within that plane, and the cavity (19) combined by both the cavity (16) and the cavity (17) at the two sections (1B₀′, 2B₀′) within this plane forms the billet (9, 109, 209,309, 509) into a shape of the hand-tool head blank member group (29, 129, 229,329, 529) at the section (B₀). When the section (1B₁′) lies within the plane (O₁O₁′O₂O₂′) formed by axes (O₁O₁′) and (O₂O₂′) of both rollers, (2B₁′) also lies within that plane, the cavity (19) combined by the cavities (16) and (17) at the two sections (1B₁′ and 2B₁′) within the plane (O₁O₁′O₂O₂′) in turn forms the billet (9, 109, 209, 309, 509) into a shape of the hand-tool head blank member group (29, 129, 229, 329, 529) at the section (B₁), in same manner, when the sections (1B₂′, 1B₃′, . . . 1Bₙ₋₁′, 1Bₙ′) lie within the plane (O₁O₁′O₂O₂′) formed by axes (O₁O₁′) and (O₂O₂′) of both rollers, the sections (2B₂′, 2B₃′, . . . 2Bₙ₋₁′, 2Bₙ′) also lie within the plane (O₁O₁′O₂O₂′) formed by axes of both rollers, the corresponding cavity (19) forms the billet (9, 109, 209, 309, 509) into the shapes of the hand-tool head blank member group (29, 129, 229, 329, 529) at the sections (B₂, B₃, . . . Bₙ₋₁, Bₙ), the rolling movement of the cavity (19) combined by both the cavity (16) and the cavity (17) continuously applies pressure to the billet (9, 109, 209, 309, 509), and the cavity (19) causes the billet (9, 109, 209, 309, 509) to be deformed at the rolling-out end into an elongate blank (35, 135, 235, 335, 535) which has section shapes of (B₀, B₁, B₂, B₃, . . . Bₙ₋₁, Bₙ) and is constituted by the hand-tool head blank member groups (29, 129, 229, 329, 529) which are joined end to end.

The further preferred solution is as follows:

The upper roller and the lower roller of said rolling mill use the driving gear and the driven gear to position the cavity and the cavity.

The driving gear and the driven gear are arc, cylindrical gears.

The driving gear and the driven gear are herring-bone gears.

Preferably, said driving gear (1) and driven gear (8) are formed in the following manner:

A section of the driving gear 1 on the upper roller (5, 105, 205), and a certain section formed by a generatrix of the roller surface on the roller (5, 105, 205) and its axis (O₁O₁′) lie in a same section, and it is set as 1C₀, a section (1C₁) formed by another roller surface generatrix and (O₁O₁′) is created using the axis (O₁O₁′) of the upper roller (5, 105, 205) as the intersection line, starting from (1C₀) and in accordance with the same direction as that from (1B₀′) to (1B₁′) and the included angle between them, a section (1C₂) formed by another roller surface generatrix and (O₁O₁′) is created starting from (1C₀) and in accordance with the same direction as that from (1B₀) to (1B₂′) and the included angle between them, and in same manner several sections (1C₃, 1C₄ . . . 1Cₙ₋₁ and 1Cₙ) are created on the driving gear (1), so as to make both the designed driving gear (1) and the designed annular cavity (16) lie the same axis (O₁O₁′) , to make the intersection lines of each section (1C₀, 1C₁, 1C₂, 1C₃, . . . 1Cₙ₋₁, 1Cₙ) and the intersection lines of each section (1B₀′, 1B₁′, 1B₂′, 1B₃′ . . . 1Bₙ₋₁′, 1Bₙ′) all lie onto the axis (O₁O₁′) of the upper roller (5, 105, 205) , to make (1C₀ and 1B₀′) lie within a same plane (1D₀), (1C₁ and 1B₁′) in a same plane (1D₁), (1C₂ and 1B₂′) in a same plane (1D₂) . . . (1Cₙ₋₁) and (1Bₙ₋₁′) in a same plane (1Dₙ₋₁), (1Cₙ) and (1Bₙ′) in a same plane (1Dₙ), and to make both sections (1Dₙ) and (1D₀) coincide with each other, the sections (1D₁, 1D₂, 1D₃, . . . 1Dₙ₋₁, 1Dₙ) form the upper roller (5, 105, 205), in which the axis (O₁O₁′) is used as the shaft center, the surface has a tooth profile (22) and the annular cavity (16), and the tooth profile (22) and the annular cavity (16) have accurate position correspondence, when the two designed rollers are placed at the corresponding assemble positions, (1B₀′) on the upper roller (5, 105, 205) and (2B₀′) of the lower roller (7, 107, 207) lie within the same plane (O₁O₁′O₂O₂′) formed by the axes (O₁O₁′) and (O₂O₂′) of the two rollers, at that position a section, which is on the driven gear (8,508) on the lower roller (7, 107, 207), is in the plane (O₁O₁′O₂O₂′) in which the section (1C₀) of the driving gear (1) of the upper roller (5, 105, 205) lies, and is formed by (O₂O₂′) and a roller surface generatrix of the driven gear (8), is set as (2C₀), so as to make (2B₀′) and (2C₀) of the driven gear (8) lie within the same section (2D₀), thus at this corresponding assembly position, both the section (1D₀) having (1B₀′) and (1C₀) therein and the section (2D₀) having (2B₀′) and (2C₀) therein are within the same plane (O₁O₁′O₂O₂′), a section (2C₁) formed by another roller surface generatrix and (O₂O₂′) is created starting from (2C₀) and in accordance with the same direction as that from (2B₀′) to (2B₁′) and the included angle between them, another section (2C₂) formed by another roller surface generatrix and (O₂O₂′) is created starting from (2C₀) and in accordance with the same direction as that from (2B₀′) to (2B₂′) and the included angle between them, and in same manner several sections (2C₃, 2C₄ . . . 2Cₙ₋₁ and 2Cₙ) are created on the lower roller (7, 107, 207), so as to make the intersection lines of each section (2C₀, 2C₁, 2C₂, 2C₃, . . . 2Cₙ₋₁, 2Cₙ) and the intersection lines of each section (2B₀′, 2B₁′, 2B₂′, 2B₃′ . . . 2Bₙ₋₁′, 2Bₙ′) all lie onto the axis of the lower roller (7, 107, 207), to make (2C₀) and (2B₀′) lie within a same plane (2D₀), (2C₁) and (2B₁′) in a same plane (2D₁), (2C₃) and (2B₃′) in a same plane (2D₃), (2Cₙ₋₁) and (2Bₙ₋₁) in a same plane (2Dₙ₋₁), (2Cₙ) and (2Bₙ′) in a same plane (2Dₙ), and to make (2D₀) coincide with (2Dₙ), the sections (2D₀, 2D₁, 2D₂, 2D₃, . . . 2Dₙ₋₁, 2Dₙ) form the lower roller (7, 107, 207), in which the axis (O₂O₂′) is used as the shaft center, its outside circular surface has a tooth profile (23) and the annular cavity (17), and the tooth profile (23) and the annular cavity (17) have accurate position correspondence, when the section (1B₀′) on the upper roller (5, 105, 205) lies within the plane (O₁O₁′O₂O₂′) formed by the axes of the two rollers, the tooth profile (22) of the driving gear (1) engages with the tooth profile (23) of the driven gear (8) to make the section (2B₀′) on the lower roller (7, 107, 207) also lie within that plane, the cavity (19) combined by the cavities (16) and (17) at the two sections (1B₀′ and 2B₀′) within the plane (O₁O₁′O₂O₂′) forms the billet (95 109, 209) into a shape of the hand-tool head blank member group (29) at the section (B₀), when the upper roller (5, 105, 205) is rotated to make the section (1B₁′) lie within the plane (O₁O₁′O₂O₂′) formed by axes of both rollers, the tooth profile (22) of the driving gear (1) drives the tooth profile (23) of the driven gear (8) to be rotated so as to make (2B₁′) on the lower roller (7, 107, 207) also lies within that plane (O₁O₁′O₂O₂′), the cavity (19) combined by the cavities (16) and (17) at the two sections (1B₁′) and (2B₁′) within that plane (O₁O₁′O₂O₂′) in turn forms the billet (9, 109, 209) into a shape of the hand-tool head blank member group (29, 129, 229, 329) at the section (B₁), in same manner, when the sections (1B₂′, 1B₃′, . . . 1Bₙ₋₁′, 1Bₙ′) lie respectively within the plane (O₁O₁′O₂O₂′) formed by axes of both rollers, the tooth profile (22) of the driving gear (1) engages with the tooth profile (23) of the driven gear (8) to make the sections (2B₂′, 2B₃′, . . . 2Bₙ₋₁′, 2Bₙ′) on the lower roller (7, 107, 207) also lie within the plane formed by axes of both rollers, the corresponding cavity (19) forms the billet (9, 109, 209) into shapes of the hand-tool head blank member group (29, 129, 229, 329) at the sections (B₂, B₃, . . . Bₙ₋₁, Bₙ), the rolling movement of the cavity (19) combined by both the cavity (16) and the cavity (17) continuously applies pressure to the billet (9, 109, 209), so as to cause the billet (9, 109, 209) to be deformed at the rolling-out end into an elongate blank (35, 135, 235, 335) which has section shapes of (B₀, B₁, B₂, B₃, . . . Bₙ₋₁, Bₙ (B_{0)), (B}₁, B₂, B₃, . . . Bₙ₋₁, Bₙ (B₀)) and is constituted by the hand-tool head blank member groups (29, 129, 229, 329) which are joined end to end.

The rolling mill for continuously rolling hand-tool head proposed in the invention is to use a computer-aid-design method, wherein according to the dimension requirements of the roller cavity and various technique parameters, the basic parameters of the driving gear and the driven gear can be conveniently, rapidly and reasonably determined, and the special requirements of the actual technique conditions, various parameters can be optimized, both rollers employ the herring-bone arc, cylindrical gear locating transmission due to the fact that the herring-bone arc, cylindrical gears have a very high contact strength, their transmission relies on the continuous transmission of the helical contact locus, the engaging joint of two gears is fixed and stationary, and therefore their moment transmission ratio is constant, thus the corresponding errors can be effectively eliminated created by the cavities on both rollers at the moment of tooth-to-tooth engagement changing transmission, when the former pair of teeth are still transferring power, the latter pair of teeth have entered into engagement, which in turn eliminates the power impact between the two rollers at the moment of tooth-to-tooth engagement changing, the various parameters of the tooth profiles of the herring-bone arc, cylindrical gears and the cavities, after being combined, are used to establish a three-dimension shape by CAD with the gear and the cavity as a unitary part, i.e. using a certain section of the cavity of the upper roller as a designing reference, a machining reference, and a measuring reference the cavity of the upper roller and the tooth profile of the transmission driving gear are machined, using a certain section of the lower roller corresponding to that section of the cavity of the upper roller as a designing reference, a machining reference, and a measuring reference of the lower roller the cavity of the lower roller and the tooth profile of the driven gear are machined, thus the tooth profiles of the transmission gears of two rollers are machined in a state where the various cavity sections correspond to each other, therefore the five kinds of errors proposed in the background art are eliminated theoretically and scientifically, thus at any angle of transmission of two rollers when the driving gear drives the driven gear, it is assured that the various corresponding sections of two cavity all can be accurately positioned and the errors will not exceed 0.02 degree, further since the designing references of both roller designed and machined by using a computer correspond to each other, the machining reference and the measuring reference of each roller are unified, the center lines of the herring-bone gear and cavity machined have accurate dimension precision, and after the two roller are assembled into a rolling mill, the centering characteristics of the herring-bone gear engagement also can be used to control the lateral location precision of the cavity. This manufacture method can be used to produce all hand-tool heads, such as a circular head hammer, a bench-work hammer, an octagonal hammer, a claw hammer, a masons hammer, various axes, a pickaxe, a pick, a claw, etc, which have strict profile requirements and dimension precisions.

On both sides of the annular cavity of the roller on said rolling mill there are provided pressure-release slots.

Along the circumference of the upper roller of said rolling mill provided is a concave locating slot, into which a part of the lower roller is embedded after being mounted, thereby further improving the lateral location precision of the both rollers.

In the cavity on the rollers there are provided blank-withdraw rods, and in the rollers there are provided blank-withdraw cams, so that forcibly demoulding can be realized to avoid the roller from being wound.

Said hand-tool head is an octagonal hammer head, and the longitudinal designed parting-surface A₁A₃ of said octagonal hammer pair group coincides with the diagonal section of the middle square portion of the octagonal hammer body.

Said rollers are formed by embedding cavity bodies onto roller bodies, thereby reducing the consumption of mould steel.

In said rolling mill, the upper roller is connected with a driving gear, the lower roller is connected with a driven gear, the driving gear drives the driven gear through two floating gears, the upward and downward movement of two floating gears can cause the annular cavity on the upper roller to rotate an angle with respect to the annular cavity 17 on the lower roller, the rolling mill proposed by the invention uses a set of roller bodies having standard gears to adapt cavity bodies of the hand-tool head having different diameter, and when the change of the cavity bodies causes the change of the distance between the centers of the rollers, the transmission precision of the gears is also not affected, at same time through moving the two floating gears upward and downward, the longitudinal location of the two cavities can be adjusted so as to not only reduce the production cost of the rollers but also facilitate industrialized production, and it is most important to realize the on-line adjustment of the cavity alignment precision.

The purpose of another aspect of the invention is that for overcoming the defects existing in the prior art there is provided a dedicated rolling mill capable of continuously rolling an irregularly shaped section for an axe head or a hammer head, wherein by continuously rolling, the energy consumption and the material cost are reduced, the labor intensity of the workers is greatly reduced, and the rate of utilization of work hour is increased. The technical solution of this aspect (first embodiment) is as follows:

A dedicated rolling mill for continuously rolling an irregularly shaped section, such as an axe head or a hammer head, comprises a plurality of groups of rollers, said each group of rollers include an upper roller, a lower roller, a driving gear, and a driven gear, said driving gear is fixed on the upper roller, the driven gear is fixed on the lower roller, the upper roller and the lower roller have same diameter, the driving gear and the driven gear are same in tooth number, the driving gear is engaged with the driven gear, on the arc surfaces of the upper roller and the lower roller there are provided continuous cavities which are concave and constantly unchanged, on the upper roller and the lower roller of the last stage of roller group among said plurality of groups of rollers there are provided cavities which are concave and have changes in their section shape and section area, and the upper roller and the lower roller correspond to each other and are combined into continuous axe head shaped cavities or hammer head shaped cavities.

On both sides of the concave and continuous axe head or hammer head shaped cavities on the arc surfaces of the upper roller and the lower roller of said last stage of roller group, there are provided pressure-release slots respectively.

On the inside surfaces of said pressure-release slots there are provided strengthening arcs.

The cavity-to-cavity gap of the upper roller and the lower roller of said last stage of roller group can be 1-3 mm.

The continuous axe head shaped cavities or hammer head shaped cavities combined by the corresponding upper roller and lower roller of said last stage of roller group among said plurality of groups of rollers is arranged in pairs with of the head shaped cavities or the hammer shaped cavities being joined head to head and tail to tail.

In said last stage of roller group within the rolling mill frame of said rolling mill, above the upper roller there are provided a roller support seat and an upper support and under the lower roller there are provided a roller support seat and a lower support.

The dedicated rolling mill for continuously rolling an irregularly shaped section, such as an axe head or a hammer head, of the invention, when being operated, according to the difference of the dimensions of the billets, first performs initial rolling, after completing the initial rolling, the profile dimensions of the material being consistent with those of the tail portion of the axe head or hammer head, performs fine rolling of the last stage, the upper roller and the lower roller are rotated relatively at same speed, when rolling the head portion of the axe head or hammer head, since the section at this time is consistent with the initial rolling dimensions, the rolling basically have no change; when rolling the tail portion of the axe head or hammer head, since the section shape at this stage has great change, the compression ratio is also relatively large, and the lateral pressure of the width-stretching deformation of the billet is high, at that time the surplus billet would pass through the cavity-to-cavity gap to enter the pressure-release slots. On the arc surfaces of the upper and lower rollers there are created locating convex edges, and locating slots in which the locating convex edges are embedded and fitted freely. When the lateral rolling pressure is very high, it is assured that the cavities of the upper and lower rollers can be accurately aligned. One turn of rotation of the upper roller and the lower roller together can accurately roll out a plurality of pairs of irregular shape billets joined together. A roller body is made to be hollow by using expensive mould steel, then a roller power shaft is made by using a common material, and the roller body and the roller power shaft are formed into a roller after being assembled. Since the roller power shaft can be used repeatedly many times and has a low material cost, the comprehensive production cost of the mould can be effectively reduced, and at same time the manufacture difficulty of the roller can also be reduced.

The dedicated rolling mill for continuously rolling an irregularly shaped section, such as an axe head or a hammer head, in this aspect of the invention, has the following beneficial effects:

1. By the present design solution, the required irregular billet can be directly rolled out, the operation efficiency is greatly improved, the labor intensity of the workers is reduced, a lot of energy can be saved, and the production cost can be reduced.

2. The rolled axe head or hammer head has a stable quality, a good mechanical performance, a high profile dimension precision, a small shape error, and a beautiful and handsome profile.

3. The utilization ratio of the material is improved, and can be increased from 70% in the prior art to above 90%.

4. The dedicated rolling mill for continuously rolling an irregularly shaped section, such as an axe head or a hammer head, of the invention can be operated simply, serve conveniently, have long life fine rollers and a low manufacture cost, and be easy to be widely used.

### BRIEF DESCRIPTION OF THE DRAWINGS

FIG. 1 is a cross sectional schematic view of the structure of the last stage of a first embodiment of the invention.

FIG. 2 is a sectional schematic view of the structure of the last stage of the first embodiment of the invention.

FIG. 3 is a development schematic view of a continuous hammer head shaped cavities on the last stage roller of the first embodiment of the invention.

FIG. 4 is a profile schematic view of an irregular shape blank of an axe head type rolled out in the first embodiment of the invention.

FIG. 5 is a profile schematic top view of FIG. 4 of the first embodiment of the invention.

FIG. 6 is a curve of an output actual rotary angle α of a lower roller 7 with respect to an alternation amount Fφ of an input angle of an upper roller in the background art of the invention.

FIG. 7 is a main view of a 16 OZ America circular head hammer of a second embodiment of the invention.

FIG. 8 is an E directional view of FIG. 7 of the second embodiment of the invention.

FIG. 9 is an F-F section view of FIG. 7 of the second embodiment of the invention.

FIG. 10 is a G-G section view of FIG. 7 of the second embodiment of the invention.

FIG. 11 is an H-H section view of FIG. 7 of the second embodiment of the invention.

FIG. 12 is a K-K section view of FIG. 7 of the second embodiment of the invention.

FIG. 13 is a main view of a circular head hammer group 29 of the second embodiment of the invention.

FIG. 14 is a design schematic view of a parting surface and a cross section of a circular head hammer blank member group 29 of the second embodiment of the invention.

FIG. 15 is a design schematic view of a parting surface and a cross section of an N side of the circular head hammer blank member group 29 of the second embodiment of the invention.

FIG. 16 is a design schematic view of a parting surface and a cross section of an S side of the circular head hammer blank member group 29 of the second embodiment of the invention.

FIG. 17 is a CAD modeling view of annular cavities 16 and 17 of S side and N side of the circular head hammer blank member group 29 of the second embodiment of the invention.

FIG. 18 is a CAD modeling view of a driving gear 1 and a driven gear 8 of the second embodiment of the invention.

FIG. 19 is a section position schematic view of 1C₀, 1B₀′ and 1D₀ of an upper roller 5 of the second embodiment of the invention.

FIG. 20 is a perspective schematic view of the upper roller 5 of the second embodiment of the invention.

FIG. 21 is a corresponding assembly position section schematic view of the upper roller 5 and a lower roller 7 of the second embodiment of the invention.

FIG. 22 is an assembly view of the upper roller 5 and the lower roller 7 of the second embodiment of the invention.

FIG. 23 is a Y-Y section schematic view of the upper roller 5 in FIG. 22 of the second embodiment of the invention.

FIG. 24 is a sectional schematic view of a rolling mill 26 of the second embodiment of the invention.

FIG. 25 is an A-A sectional schematic view of FIG. 24 of the second embodiment of the invention.

FIG. 26 is an M directional schematic view of FIG. 24 of the second embodiment of the invention.

FIG. 27 is a schematic view of a roller embedded and equipped with a cavity of the second embodiment.

FIG. 28 is a perspective view of a masons hammer head 527′ of a third embodiment.

FIG. 29 is a perspective view of a masons hammer head 527 of the third embodiment.

FIG. 30 is a perspective view of a masons hammer head blank member group 529 of the third embodiment.

FIG. 31 is a schematic view of a design parting surface of the masons hammer head blank member group 529 of the third embodiment.

FIG. 32 is a schematic view of a transmission system of a rolling mill for continuously rolling a masons hammer head, of the third embodiment.

FIG. 33 is an A directional schematic view of FIG. 32.

FIG. 34 is a section schematic view of the rolling mill 526 for continuously rolling a masons hammer head, of the third embodiment.

FIG. 35 is an F directional schematic view of FIG. 34.

FIG. 36 is an L-L section schematic view of FIG. 35.

FIG. 37 is a Q-Q sectional view of FIG. 34.

FIG. 38 is a perspective view of an axe head of a fourth embodiment.

FIG. 39 is a perspective view of an axe head 127 having technique indentations 28 of the fourth embodiment.

FIG. 40 is a perspective view of an axe head blank member group 129 having the technique indentations 28 of the fourth embodiment.

FIG. 41 is a continuous rolling schematic view of the axe head blank member group 129 of the fourth embodiment.

FIG. 42 is a perspective view of an octagonal hammer head 27 of a fifth embodiment.

FIG. 43 is a perspective view of an octagonal hammer head group 29 of the fifth embodiment.

FIG. 44 is a schematic view of a design parting surface of the octagonal hammer head group 29 of the fifth embodiment.

FIG. 45 is a schematic view of a continuous production line of the octagonal hammer head of the fifth embodiment.

FIG. 46 is a schematic view of a heat saw of the fifth embodiment.

FIG. 47 is a schematic view of a residual heat quenching machine tool of the fifth embodiment.

FIG. 48 is a continuous polishing and grinding schematic view of an octagonal hammer blank member group 229 of the fifth embodiment.

FIG. 49 is a drilling and machining schematic view of a fitting-hole of an octagonal hammer head 227 of the fifth embodiment.

FIG. 50 is a reshaping schematic view of a fitting-hole after being drilled of FIG. 49.

FIG. 51 is a perspective view of a body-joined masons hammer of a sixth embodiment.

FIG. 52 is a main view of a body-joined masons hammer group of the sixth embodiment.

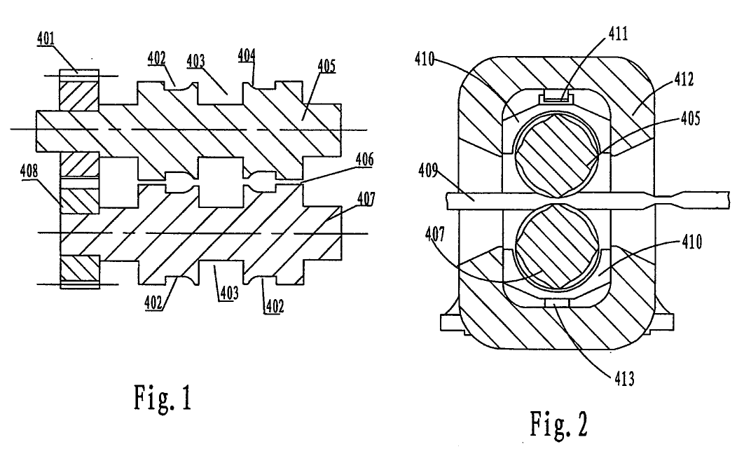

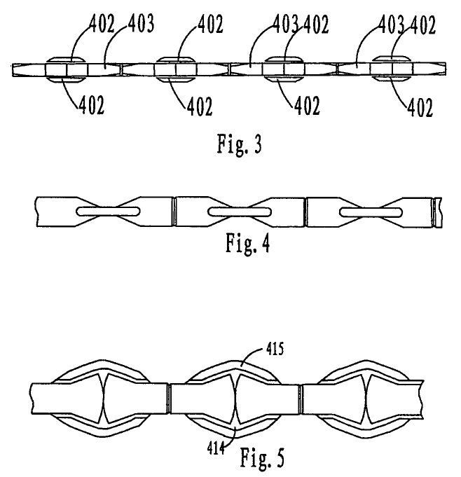

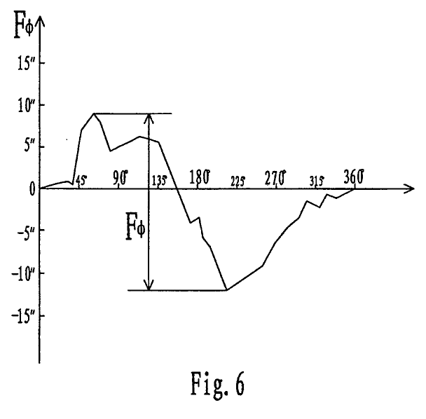

### ILLUSTRATION OF THE REFERENCE NUMBERS

| | |
|---|---|
| 12. | Rolling mill frame |
| 401. | Driving gear |
| 402. | Pressure-release slot |
| 403. | Cavity |
| 404. | Strengthening arc |
| 405. | Upper roller |
| 406. | Cavity-to-cavity gap |
| 407 | Lower roller |
| 408. | Driven gear |
| 409. | Billet |
| 410. | Roller support seat |
| 411. | Upper support |
| 413. | Lower support |
| 414. | Cavity-to-cavity gap flash |
| 415. | Pressure-release slot flash |

B₀, B₁, B₂, B₃ . . . Bₙ₋₁, Bₙ Cross sections of several set positions of circular head hammer blank member group 29

1B₀, 1B₁, 1B₂, 1B₃ . . . 1Bₙ₋₁, 1Bₙ Cross sections of several set positions of N side of circular head hammer blank member group 29

2B₀, 2B₁, 2B₂, 2B₃ . . . 2B_{n-1, 2B}ₙ Cross sections of several set positions of S side of circular head hammer blank member group 29

1B₀′, 1B₁′, 1B₂′, 1B₃′ . . . 1Bₙ₋₁′, 1Bₙ′ Sections of several set positions formed by roller surface generatrix and axis O₁O₁′ of annular cavity 16 on formed upper roller 5

2B₀′, 2B₁′, 2B₂′, 2B₃′ . . . 2Bₙ₋₁′, 2Bₙ′ Sections of several set positions formed by roller surface generatrix and axis O₂O₂′ of annular cavity 17 on formed lower roller 7

O₁O₁′ Axis of upper roller 5

O₂O₂′ Axis of lower roller 7

1C₀, 1C₁, 1C₂, 1C₃ . . . 1Cₙ₋₁, 1Cₙ Sections of several set positions formed by roller surface generatrix of driving gear 1 on formed upper roller 5 and axis O₁O₁′

2C₀, 2C₁, 2C₂, 2C₃ . . . 2Cₙ₋₁, 2Cₙ Sections of several set positions formed by roller surface generatrix of driven gear 8 on formed lower roller 7 and axis O₂O₂′

A₁A₃ Parting surface of circular head hammer blank member 29

N Upper side part of parting surface of circular head hammer blank member 29.

S Lower side part of parting surface of circular head hammer blank member group 29.

1A₁1A₃ N side parting surface of circular head hammer blank member group 29.

2A₁2A₃ S side parting surface of circular head hammer blank member group 29.

1A₁1A₃′ N side annular parting surface of circular head hammer blank member group 29.

2A₁2A₃′ S side annular parting surface of circular head hammer blank member group 29.

T Head end

W Tail end

1D₀ Section formed by designing 1B₀′ and 1C₀ in same plane on upper roller 5.

1Dₙ Section formed by designing 1Bₙ′ and 1Cₙ in same plane on upper roller 5.

2D₀ Section formed by designing 2B₀′ and 2C₀ in same plane on upper roller 7.

2Dₙ Section formed by designing 2Bₙ′ and 2Cₙ in same plane on upper roller 7.

DR Power input end

α Actual rotary angle of lower roller 7

Fφ Alternation amount of output actual rotary angle α of lower roller 7 with respect to input rotary angle of upper roller 5,

| | |
|---|---|
| 1. | Driving gear |
| 2. | Pressure-release slot |
| 3. | Cavity body |
| 4. | Roller body |
| 5. | Upper roller |
| 7. | Lower roller |
| 8. | Driven gear |
| 9. | Billet |
| 10. | Roller support seat |
| 11. | Upper support |
| 13. | Lower support |
| 16. | Annular cavity |
| 17. | Annular cavity |
| 18. | Blank-withdraw rod fitting-hole |
| 19. | Combined cavity |
| 20. | Locating slot |
| 21. | Blank-withdraw rod cam fitting-hole |
| 22. | Tooth profile |
| 23. | Tooth profile |
| 24. | Blank-withdraw rod |
| 25. | Blank-withdraw cam |
| 26. | Rolling mill |
| 27 | Circular head hammer blank member |
| 27′ | Circular head hammer |
| 28. | Technique indentation |
| 29. | Circular head hammer blank member group |
| 35. | Blank |
| 54. | Blank-withdraw rod retainer ring |
| 105. | Upper roller |
| 107. | Lower roller |
| 109. | Billet |
| 126. | Rolling mill |
| 127. | Axe head blank member |
| 127′. | Axe head |
| 128. | Axe head technique indentation |
| 129. | Axe head blank member group |
| 130. | Conventional rolling mill |
| 134. | Rough billet |
| 135. | Blank |
| 140. | Axe head hole |
| 205. | Upper roller |
| 207. | Lower roller |
| 209. | Billet |
| 226. | Rolling mill |
| 227. | Octagonal hammer blank member |
| 227′. | Octagonal hammer |
| 229. | Octagonal hammer blank member group |
| 230. | Conventional rolling mill |
| 231. | Crystallizer |
| 234. | Rough billet |
| 235. | Blank |
| 236. | Grinding wheel |
| 237. | Control dragging block |
| 238. | Heat saw device |
| 239. | Heat saw blade |
| 240. | Octagonal hammer fitting-hole |
| 241. | Punch head |
| 242. | Drilling bit |
| 243. | Heat saw bearing seat |
| 244. | Saw shaft |
| 245. | Holding plate |
| 246. | Spacer |
| 247. | Pulley |
| 248. | Positioning and holding device |
| 249. | Quenching machine tool conveyer belt pulley |
| 250. | Medium spray head |
| 251. | Quenching conveyer belt |
| 252. | Quenching machine tool |
| 327. | Body-joined masons hammer head blank member |
| 327′. | Body-joined masons hammer head |
| 329. | Body-joined masons hammer head blank member |
| | group |
| 335. | Blank |
| 501. | Driving gear |
| 503. | Cavity body |
| 504 | Roller body |
| 505. | Upper roller |
| 507. | Lower roller |
| 508. | Driven gear |
| 509. | Billet |
| 510. | Floating gear |
| 511. | Floating gear |
| 513, 514, 515. | Shaft |
| 515. | Worm wheel |
| 516. | Worm |
| 517. | Screw |
| 523, 539, 537, 530. | Coupling plate |
| 526. | Rolling mill |
| 527. | Masons hammer head blank member |
| 527′. | Masons hammer head |
| 528. | Technique indentation |
| 529. | Masons hammer head blank member group |
| 535. | Blank |
| 540. | Fitting-hole |
| 563. | Cavity body |
| 564 | Roller body |
| S. | Upward direction of floating gears 510, 511 |
| −S. | Downward direction of floating tooth trans- |
| | mission lines 511, 510 |

### DETAILED DESCRIPTION OF THE PREFERRED EMBODIMENT

### First Embodiment

The first embodiment of the invention is an optimized implement solution of a rolling mill for rolling a blank for a Germany bench-work hammer head of 500 grams, which rolling mill comprises a upper roller 405, a lower roller 407, one end of the upper roller 405 and the lower roller 407 is provided with a driving gear 401 and a driven gear 408 respectively, on the other end of the upper roller 405 the power from a preceding rolling mill is transferred through a shaft coupler to cause the upper roller 405 to rotate and through the driving gear 401 provided on the upper roller 405 to drive the driven gear 408, both gears have same pitch diameters and tooth numbers, when the upper roller 405 is rotated, the lower roller 407 is driven at same time to rotate at equal speed in an opposite direction, it can be assured that the upper roller 405 and the lower roller 407 have an accurate transmission ratio and a high rotary correspondence accuracy, on the upper roller 405 and the lower roller 407 used is an arrangement joining a head and a tail of a cavity of the hammer one forward and the other backward, that is, the hammer head cavity on each roller is formed by joining head to head and tail to tail, i.e. to form a continuous cavity 403 in an arrangement manner of joined equal sections.

The rolling mill of 500-gram hammer head blank member of the embodiment can roll 8 hammer heads joined together when the rollers are rotated one turn, and since the dimension of the square work section of the head end of hammer head type blank of 500-gram weight are 6 times larger than that of the flat work end of the tail-end, the cavity is arranged in a square head to square head and flat head to flat head joined manner, so as to avoid dramatic variation of the section. portions when the blank is formed in the cavity, and in spite of the section variation, the compressing process becomes a relatively smooth process, making such a blank of hammer head type with large section variation able to be well formed in the rolling cavity.

In the rolling mill of 500-gram hammer head blank member of the embodiment, the diameters of the upper roller 405 and the lower roller 407 are reduced by 2 mm respectively, and depths of the cavities 403 on the upper roller 405 and the lower roller 407 are reduced by 1 mm respectively, so that a roller-to-roller gap 406 of 2 mm is formed, on both sides of the cavity 403 at a distance of 10 mm from its edges are provided with pressure-release slots 402, the section area of which is dependent on the forming compression ratio in the corresponding cavity 403, at the maximum compression ratio portion of the rolling mill of 500-gram hammer head blank member rolling mill, the maximum section size of the provided pressure-release slots is 27 mm×6 mm, the active action of this design solution is in that, the product, such as a hammer head, with a section variation, when being formed in a cavity, have greatly different flow pressures in various portions, the blank at normal volume compression ratio part has relatively small rolling metal flow pressure, for the cavity-to-cavity gap 406 of 2 mm between the upper roller 405 and the lower roller 407, the friction action of both rollers can effectively resist the lateral flow of the metal, and at this time the cavity-to-cavity gap 406 functions as a damping seal, so as to not only assure that the blank in the cavity 403 at a certain forming pressure is fully filled into the cavity 403, but also avoid flashes from occurring; whereas at the relatively small forming section part, the rolling deformation compression ratio is large in the cavity, and when the metal flow pressure of such part rises to certain degree, a part of metal would pass through the cavity-to-cavity gap 406 against friction resistance of the roller surfaces, and enter into the pressure-release slots 402 after the lateral pressure is damped to become small and the flow speed is damped to become slow, in the product of the rolled blank 409, through the cavity-to-cavity gap 406 and the pressure-release slots 402, the surplus metal flow creates a cavity-to-cavity gap flash 414 and a pressure-release slot flash 415, so as to assure that the products of stable dimensions are rolled using the reasonable and scientific cavity design; on the inside surfaces of the pressure-release slots 402 there are provided strengthening arcs 404 to reduce stress concentration phenomena occurred often at those places, so that the use lives of the upper roller 405 and the lower roller 407 are further increased.

An embodiment of an axe head blank member rolling mill in the invention is substantially same in rolling mill structure as the rolling mill of 500-gram hammer head blank member, and is not repeated here; and for the axe head shaped cavities structure on the rollers, see the profile schematic view of the rolled irregular blank of the axe head type shown in FIG. 4 and FIG. 5.

### Second Embodiment

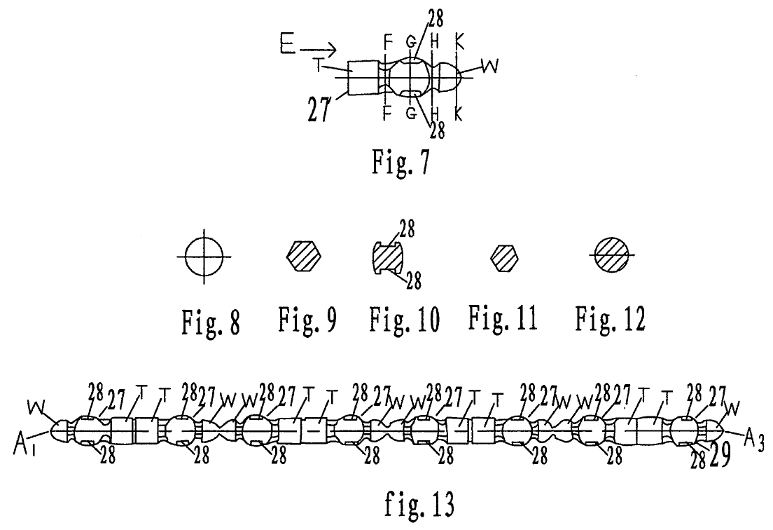

A hand-tool head manufacture method in the second embodiment will be described using the manufacture method of 16 OZ America circular head hammer head 27′ shown in FIG. 7 to FIG. 13 as one example of the hand-tool head.

A rolling mill 26 is first used to roll out a elongate blank 35 constituted by circular head hammer head blank members in which positions of fitting-holes are provided with technique indentations 28 of sunken-hole type that have sectional shapes same as those of the fitting-holes, and after being cut off into circular head hammer head blank members 27, handle-fitting holes are punched at the hammer holes along the technique indentations 28 by using a hole-punching technology.

For the convenience of description, either roller of the rolling mill 26 is referred as an upper roller 5, and an equipped locating gear is referred as a driving gear 1, whereas the other corresponding roller is referred as an lower roller 7, and an equipped locating gear is referred as a driven gear 8, but the terms “upper” and “lower” in the upper roller and the lower roller are irrespective of their actual mount positions, and the driving gear and driven gear are also irrespective of their actual transmission manner. Similarly, for the convenience of description, the cavity alignment of the two-roller annular cavities along the circumference direction is referred as a longitudinal location, whereas the cavity alignment location in the cavity widthwise direction as a lateral location.

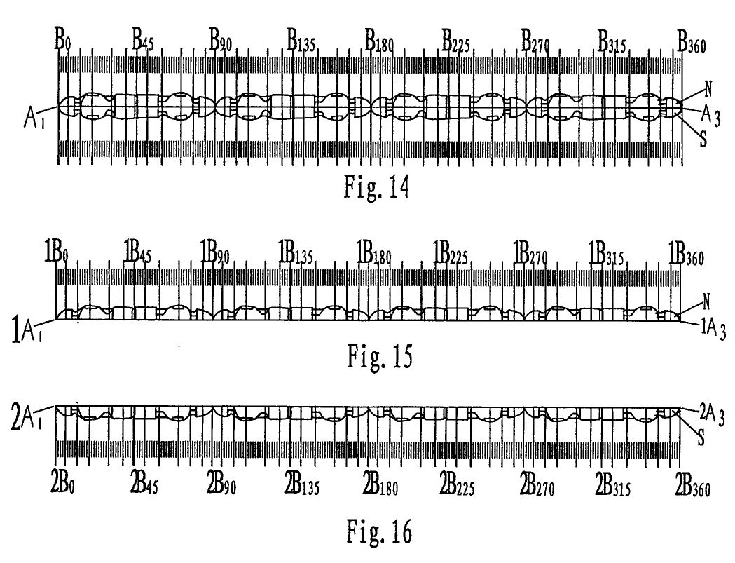

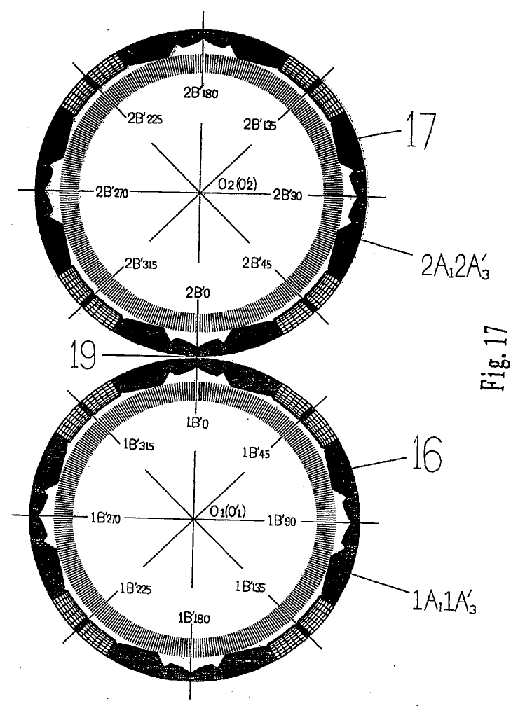

FIG. 13 shows that using CAD (Computer Aid Design), 8 pieces of 16 OZ America circular head hammers 27′ are arranged into a head-end T to head-end T joined and tail-end W to tail-end W joined circular head hammer group 29 and 360 cross sections B₀, B₁, B₂, B₃, . . . , B₃₆₀ perpendicular to a parting surface A₁A₃ are formed starting from one end of the parting surface A₁A₃, as shown in FIG. 14, FIG. 15 and FIG. 16, several cross sections 1B₀, 1B₁, 1B₂, 1B₃, . . . 1B₃₆₀ and 2B₀, 2B₁, 2B₂, 2B₃, . . . 2B₃₆₀ are formed on the circular head hammer portion on the upper side, i.e. the N side, of the parting surface and the circular head hammer portion on the lower side, i.e. the S side, of the parting surface, starting from intersecting positions of B₀, B₁, B₂, B₃, . . . B₃₆₀ with the parting surface, as shown in FIG. 17, the parting surface 1A₁A₃ of the circular head hammer on the N side is bent, in a manner making the parting surface be outside, into a circular parting surface 1A₁A₃′ with 1B₀ coinciding with 1B₃₆₀, and it is made that the planes in which the various sections of 1B₀, 1B₁, 1B₂, 1B₃, . . . 1B₃₆₀ exist are all intersected with the axis O₁O₁′ of the upper roller 5 using the axis O₁O₁′ as intersection line, those sections become several sections 1B₀′, 1B₁′, 1B₂′, 1B₃′, . . . 1B₃₆₀′ which use the axis O₁O₁′ of the upper roller 5 as the axis and the circumference of the upper roller 5 as the section outside, so that the various sections of 1B₀′, 1B₁′, 1B₂′, 1B₃′, . . . 1B₃₆₀′ form an upper roller 5 whose surface has a annular cavity 16, the parting surface 2A₁A₃ of the circular head hammer on the S side is bent, in a direction opposite to that of 1A₁A₃′ on the upper roller 5 and in a manner making the parting surface be outside, into a circular parting surface 2A₁A₃′ with 2B₀ coinciding with 2B₃₆₀, and it is made that the planes in which the various sections of 2B₀, 2B₁, 2B₂, 2B₃, . . . 2B₃₆₀ exist are intersected with the axis O₂O₂′ of the lower roller 7 using the axis O₂O₂′ as intersection line, those sections become several sections 2B₀′, 2B₁′, 2B₂′, 2B₃′, . . . 2B₃₆₀′ which use the axis of the lower roller 7 as the axis O₂O₂′ and the circumference of the lower roller 7 as the section outside and are arranged with an included angle between them in a opposite direction starting from 1B₀, 1B₁, 1B₂, 1B₃, . . . 1B₃₆₀ on the upper roller 5, so that the various sections of 2B₀′, 2B₁′, 2B₂′, 2B₃′, . . . 2B₃₆₀′ form a lower roller 7 whose surface has a annular cavity 17. And the cavity 16 and the cavity 17 are draw as a three-dimension shape as shown in FIG. 17 on a computer.

In order to accurately locate the annular cavities 16 and 17 on the upper roller 5 and the lower roller 7 upon rolling, using the driving gear 1 equipped on the upper roller 5 and the driven gear 8 equipped on the lower roller 7, a power input from a DR end of the upper roller drives the lower roller 7 through the gears 1 and 8 while causing the upper roller 5 to rotate.

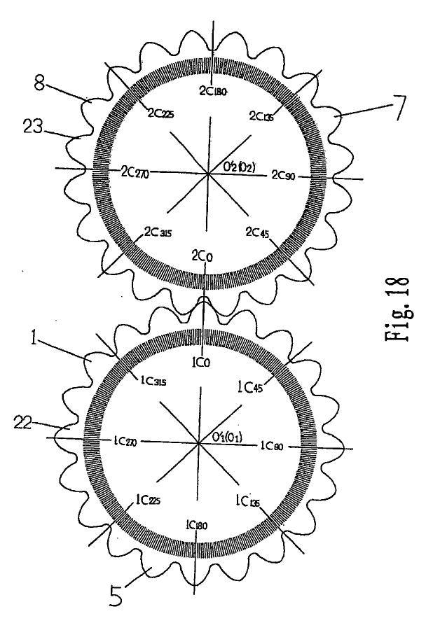

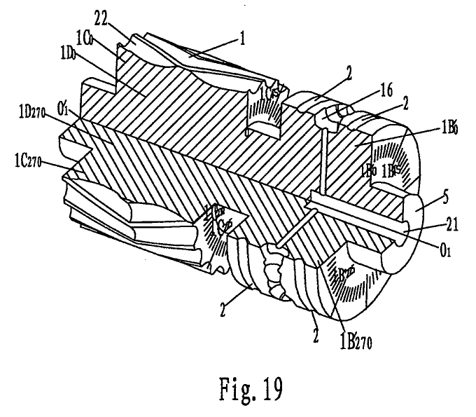

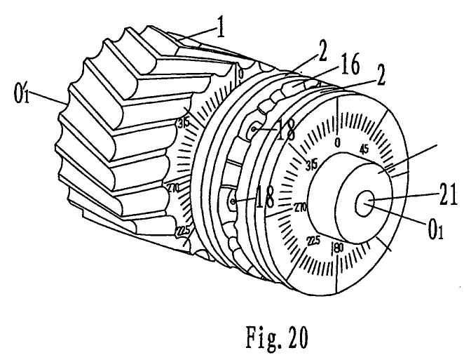

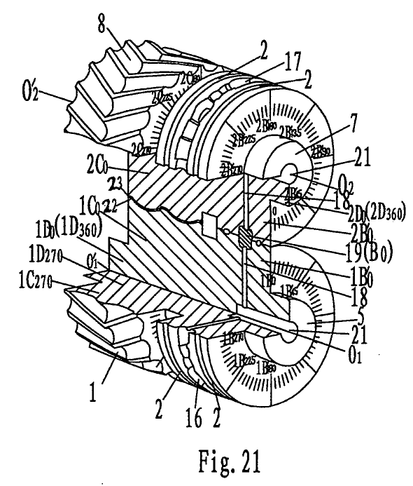

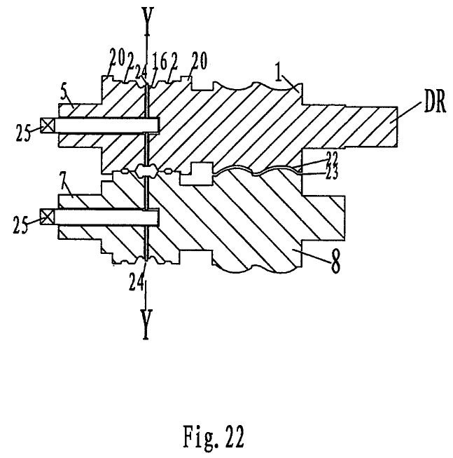

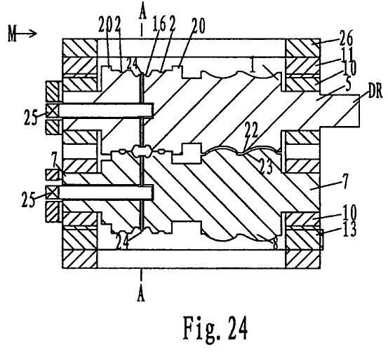

As shown in FIG. 17, FIG. 18, FIG. 19, FIG. 20 and FIG. 21, when in accordance with the designed cavity form dimensions and the dimension tolerances of the formed hand-tool head, by combining with the rolling technique of the material used for manufacturing circular head hammer or other parameters, the maximum transmission errors of each corresponding sections on the whole circumference of the annular cavities 16 and 17 on two rollers when the circular head hammer group 29 of this specification is pre-formed are calculated, so as to design the technical data of a pair of transmission gears which are able to still have high reliability and high transmission accuracy when they transfer a heavy load of 1000-2000 KW and the load is a impacting and changing load, in accordance with such data it is determined which tooth profile engagement transmission, shape of the tooth surface, tooth thickness, tooth height, and gear width should be selected and used, and in accordance with the design dimension data of the transmission two-roller cavities 16 and 17 and the required corresponding accuracy it is determined which tooth profile engagement transmission, and tooth numbers and gear modulus of two gears, pitch diameters, addendum circle diameters and helical angles should be selected and used, as shown in FIG. 19, FIG. 21, FIG. 22 and FIG. 24, in order to assure the transmission accuracy between teeth, to reduce the corresponding transmission errors of the two-roller cavity generated at the change moment of the meshing teeth, to reduce impact, and to be capable of using the engagement centering characteristics of the herring-bone gear to control the lateral location of the cavity, the driving gear 1 and the driven gear 8 of two rollers employ the herring-bone arc, cylindrical gears. Using these data and parameters, by CAD a three-dimension shapes are designed of the driving gear 1 and the driven gear 8 as shown in FIG. 18, FIG. 19 and FIG. 20, and a section passing the axis, of the designed driving gear 1 on the upper roller 5, is set as 1C₀ by using a computer, using the axis of the upper roller 5 as the intersection line, 1C₁ is formed starting from 1C₀ in accordance with the same direction as that from 1B₀′ to 1B₁′ and the included angle between them, 1C₂ is formed starting from 1C₀ and in accordance with the same direction as that from 1B₀ to 1B₂′ and the included angle between them, and in same manner several sections 1 C₃, 1C₄ . . . and 1C₃₆₀ are formed on the driving gear 1, so as to make the intersection lines of each section 1C₀, 1C₂, 1C₃, . . . 1C₃₆₀ and intersection lines of each section 1B₀′, 1B₁′, 1B₂′, 1B₃′ . . . 1B₃₆₀′ all lie onto the axis of the upper roller 5, to make 1C₀ and 1B₀ lie in a same plane 1D₀, 1C₁ and 1B₁′ in a same plane 1D₁, 1C₂ and 1B₂′ in a same plane 1D₂, . . . 1C₃₆₀ and 1B₃₆₀′ in a same plane 1D₃₆₀, and to make two sections 1D₃₆₀ and 1D₀ coincide with each other, i.e. the sections 1D₁, 1D₂, 1D₃, . . . 1D₃₆₀ form the upper roller 5, in which as shown in FIG. 20, the axis of the upper roller 5 is used as the shaft center, its surface has a tooth profile 22 and the annular cavity 16 and the tooth profile 22 and the annular cavity 16 have accurate position correspondence, as shown in FIG. 21, when two rollers are at the design corresponding positions, 1B₀′ of the upper roller 5 and 2B₀′ of the lower roller 7 lie in the same plane formed by the axes of the two rollers, at that position a section of the driven gear 8 on the lower roller 7 in the plane in which the driving gear 1 on the upper roller 5 lies and which is formed by the axes of the two upper and lower rollers is set as 2C₀, 2C₂ is formed starting from 2C₀ in accordance with the same direction as that from 2B₀′ to 2B₂′ and the included angle between them, and in same manner several sections 2C₃, 2C₄ . . . 2C₃₆₀ are formed on the lower roller 7, so as to make the intersection lines of each section 2C₀, 2C₂, 2C₃, . . . 2C₃₆₀ and the intersection lines of each section 2B₀′, 2B₁′, 2B₂′, 2B₃′ . . . 2B₃₆₀′ all lie onto the axis of the lower roller 7, to make 2C₀ and 2B₀′ lie in a same plane 2D₀, 2C₁ and 2B₁′ in a same plane 2D₁, 2C₃ and 2B₃′ in a same plane 2D₃, . . . 1C₃₆₀ and 1B₃₆₀′ in a same plane 1D₃₆₀, and to make 2D₀ coincide with 2D₃₆₀, i.e. the sections 2D₀, 2D₁, 2D₂, 2D₃, . . . 2D₃₆₀ form the lower roller 7, in which the axis of the lower roller 7 is used as the shaft center, its surface has a tooth profile 23 and the annular cavity 17 and the tooth profile 23 and the annular cavity 17 have accurate position correspondence, the upper roller 5 and the lower roller 7 designed by using computer serve as a unitary part to establish a CAD three-dimension shape and to draw up a machining program, which is input into a numerical control machine tool to work out the upper roller 5 and the lower roller 7.

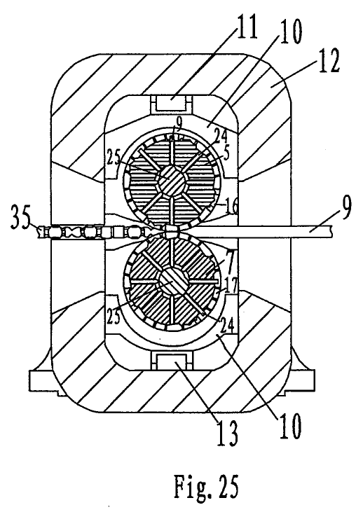

As shown in FIG. 21, FIG. 22, FIG. 24 and FIG. 25, the upper roller 5 and the lower roller 7 are mounted onto a rolling mill frame 12 to become a rolling mill 26 for continuously rolling the circular head hammer, the upper roller 5, through the driving gear 1 and the driven gear 8, drives the lower roller 7 to rotate in a opposite direction at corresponding position on the rolling mill 26, i.e. to perform rolling formation, as shown in FIG. 21, when the section, 1B₀′ on the upper roller 5 lies within the plane O₁O₁′O₂O₂′ formed by the center lines of the two rollers, the tooth profile 22 of the driving gear 1 and the tooth profile 23 of the driven gear 8 engage with each other to make the section 2B₀′ on the lower roller 7 also lie within that plane, i.e. 1D₀ and 2D₀ lie within a same plane, within which a cavity 19 formed by combining the cavities 16 and 17 at the two sections 1B₀′, 2B₀′ can form a billet 9 into a shape of the circular head hammer blank member group 29 at the section B₀, when the section 1B₁′ on the upper roller 5 lies within the plane O₁O₁′O₂O₂′ formed by the center lines of the two rollers, the tooth profile 22 of the driving gear 1 and the tooth profile 23 of the driven gear 8 engage with each other to make the section 2B₁′ on the lower roller 7 also lie within that plane, i.e. 1D₁ and 2D₁ lie within a same plane, within which the cavity 19 formed by combining the cavities 16 and 17 at the two sections 1B₁′, 2B₁′ can also form the billet 9 into a shape of the circular head hammer blank member group 29 at the section B₁, in same manner, when 1B₂′, 1B₃′ . . . 1B₃₆₀′ lie within the plane formed by the center lines of the two rollers respectively, the tooth profile 22 of the driving gear 1 and the tooth profile 23 of the gear 8 engage with each other to make the sections 2B₂′, 2B₃′ . . . 2B₃₆₀′ on the lower roller 7 also lie within the plane formed by the center lines of the two rollers correspondingly, i.e., the corresponding cavities 19 when 1D₂ and 2D₂, 1D₃ and 2D₃ . . . 1D₃₆₀ and 2D₃₆₀ lie within a same plane respectively can form the billet 9 into shapes of the circular head hammer blank member group 29 at the sections B₂, B₃, . . . B₃₆₀, the rolling motion of the cavities 19 formed by combining both cavity 16 and cavity 17 continuously apply pressures to the billet 9 to deform it at a rolling-out end into a elongate blank 35 which has section shapes of B₀, B₁, B₂, B₃, . . . B₃₆₀, (B_{0), B}₁, B₂, B₃, . . . B₃₆₀ and is constituted by the end-joined circular head hammer blank member group 29.

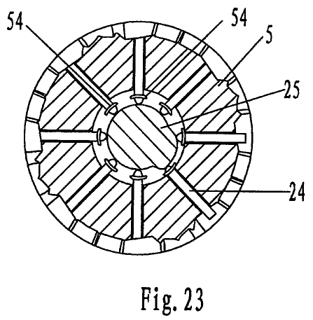

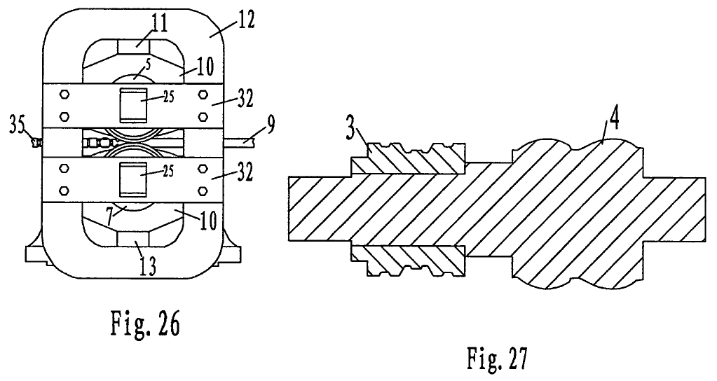

For easy demoulding upon rolling, as shown in FIG. 21, FIG. 22, FIG. 23, FIG. 24, FIG. 25 and FIG. 26, in the cavity of the roller there are provided blank-withdraw rod fitting-holes 18, in each of which a blank-withdraw rod 24 is fitted, on the bottom end of each blank-withdraw rod 24 there is provided with a retainer ring 54 whose action is to prevent the blank-withdraw rod 24 from dropping, at the shaft center position of the roller there is provided with a blank-withdraw cam fitting-hole 21 in which a blank-withdraw cam 25 for pushing out the blank-withdraw rods 24 is mounted, as shown in FIG. 26, when the rollers are driven, the blank-withdraw cam 25 is stationary relative to the roller under action of a blank-withdraw plate 32, the drive of the roller would cause, through the blank-withdraw rod fitting-holes 18 in the cavity, the blank-withdraw rods 24 to rotate around the blank-withdraw cam 25 and the bottom ends of the blank-withdraw rods 24 in the blank-withdraw rod fitting-holes 18 to move along the outer profile of the blank-withdraw cam 25, thus when the bottom ends of the blank-withdraw rods 24 are located onto the normal profile portion of the cam 25, their top ends will be flush with the bottom of the cavity, but when the blank-withdraw rods 24 move onto the pushing profile portion of the cam 25, the cam 25 will push the blank-withdraw rods 24 to the position above the bottom of the cavity, so as to push the blank out of the cavity and to realize the demoulding.

As shown in FIG. 7, FIG. 8, FIG. 9, FIG. 10, FIG. 11, FIG. 12 and FIG. 13, since variations of various sections of the circular head hammer blank member group 29 are great, upon rolling formation, in its formation cavity the flow pressures of the various portions are much different, the blank at normal volume compression ratio part has relatively small rolling metal flow pressure, at the normal rolling pressure, the friction action of the surfaces of both rollers can effectively resist the lateral flow of the metal, and at this time it is assured that the blank 35 in the cavity 19 formed by combining the annular cavities 16 and 17 has proper formation pressure, can be fully filled into the cavity, and also avoid flashes from occurring, whereas at the relatively small formation section part, the rolling deformation compression ratio is large in the cavity, and when the metal flow pressure of such part rises to certain degree, it is possible to generate large forward slip and backward movement, causing the rolled circular head hammer blank member to deform seriously, the dimensions of the blank 35 to be also instable, and the mould to crack, as shown in FIG. 21, FIG. 22 and FIG. 24, on the rollers there are provided the pressure-release slots 2, when the metal flow reaches a certain pressure, a part of metal would overcome the friction resistance of the roller surfaces, and enter into the pressure-release slots 2, so as to assure that the rolled products have stable dimensions and that the cavity can be effectively avoided from cracking, thereby improving the use lives of the moulds.

As shown in FIG. 21 and FIG. 24, in order to further improve the lateral cavity alignment accuracy of the two rollers, along the circumference of the upper roller 5 of the rolling mill 26 is made with a concave locating slot 20, into which a part of the lower roller 7 is embedded after mounted, thereby functioning as a lateral location.

As shown in FIG. 27, a roller body 4 is made of a common material, and its cavity body 3 is made of mould steel, and the roller body 4 and cavity body 3 are assembled into a roller, thereby saving mould steel.

The elongate blank 35 is cut off at the joined end of the circular head hammer head blank members 27 and become the circular head hammers 27′.

For reducing cost and improving efficiency, the elongate blank 35, after being wholly made heat-treatments, such as quenching, normalizing, and tempering, by using the rolling residual heat, is cut off in accordance with length of the circular head hammer and becomes the circular head hammers 27′.

For further reducing cost, the heat-rolled elongate blank 35 is heat-sawed after being heat-rolled, so as to be cut off and become the circular head hammers 27′, they are heat-treated by using the rolling residual heat, since the circular head hammer generally requires a high hardness (HRC50-58) at the ends and a low hardness (HRC30) at the middle body, thus the blank 35 after being heat-rolled is heat-sawed to form the circular head hammers 27 above the quenching, and their ends are locally quenched, so that by one time of heating, the circular head hammers 27′ can be produced which conform to not only geometric dimension standards but also physical performances.

### Third Embodiment

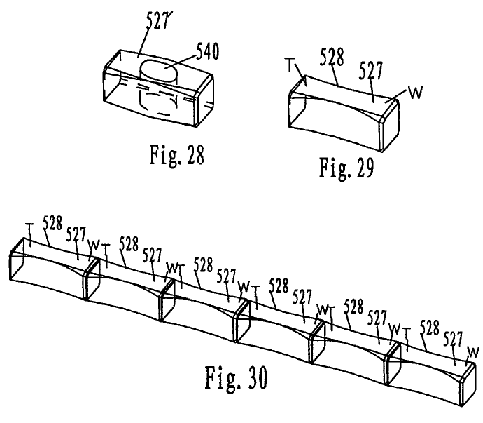

As shown in FIG. 28 to FIG. 37, a manufacture method of a masons hammer with technique indentations and a rolling mill 526 with a two-ring-cavity longitudinal cavity align adjusting device is described.

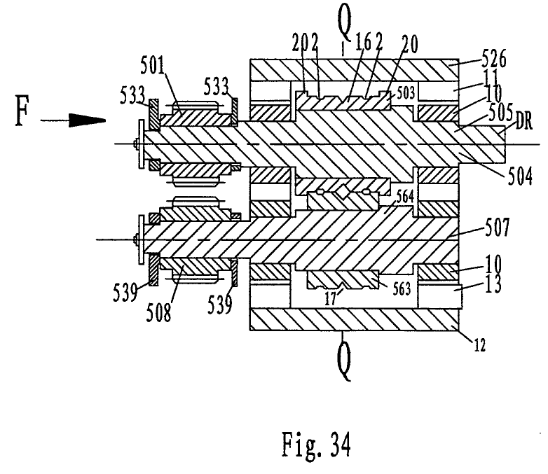

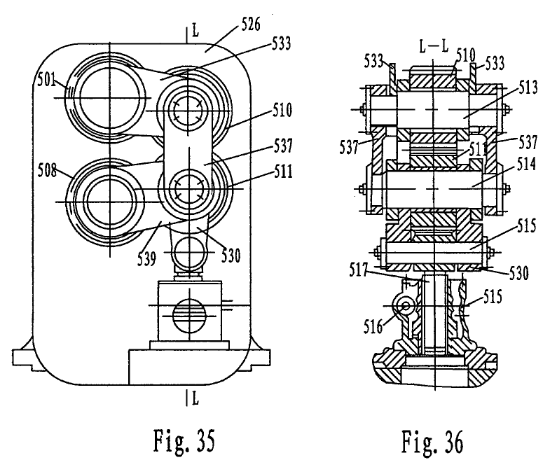

As shown in FIG. 34, FIG. 35 and FIG. 36, the rolling mill 526 comprises a frame 12, a upper roller 505 which includes a roller body 504, a cavity body 503 and a driving gear 501, a lower roller 507 which includes a roller body 564, a cavity body 563 and a driven gear 508.

As shown in FIG. 34, FIG. 35 and FIG. 36, the rolling mill 526 further comprises the two-ring-cavity longitudinal cavity align adjusting device which includes floating gears 510, 511, shafts 513, 514, 515, coupling plates 533, 539, 537, 530, a screw 517, a worm wheel 515, and worm 516.

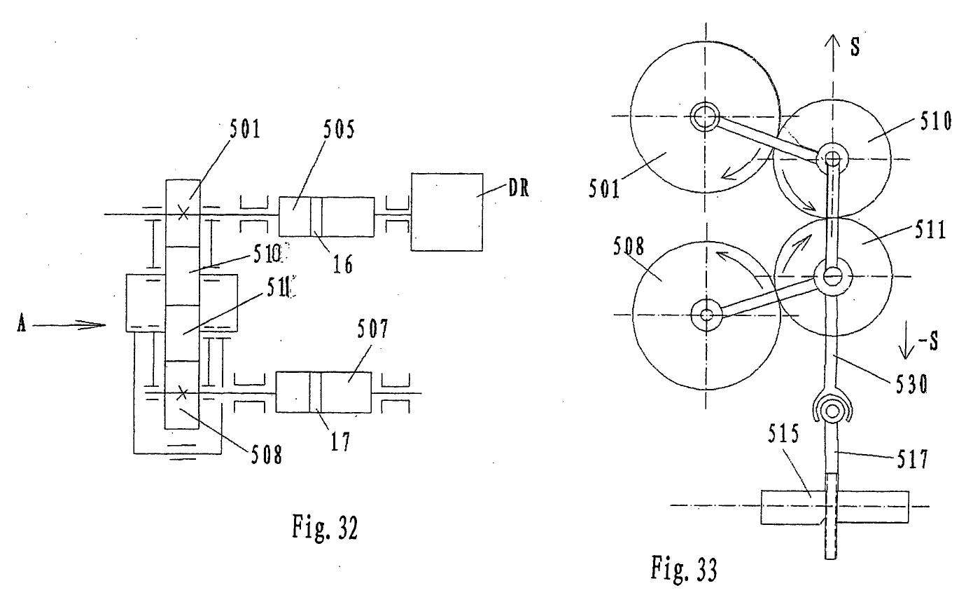

The transmission principle of the device is shown in FIG. 32 and FIG. 33, wherein the power drives, via the DR end of the upper roller 505, the driving gear 501 on same roller, which gear 501 drives, through two floating gears 510 and 511, the driven gear 508 on the lower roller 507, causing two rollers to rotate in correspondingly opposite directions, when the worm wheel 515 with a nut is rotated, the screw 517 would be lengthened or shortened with respect to the worm wheel, causing the screw 517, through the coupling plates 533, 539, 537, 530, to move two floating gears 510 and 511 upward in S direction or downward in −S direction, thereby causing a annular cavity 16 of the upper roller 505 to rotate an angle with respect to a annular cavity 17 on the lower roller 507, when the cavity-to-cavity gap is adjusted, the distance between the centers of the upper roller 505 and the lower roller 507 would have some change, this structure would not affect the engagement gap of this group of gears and the transmission quality, to facilitate the convenient adjustment of the cavity-to-cavity gap of the rollers.

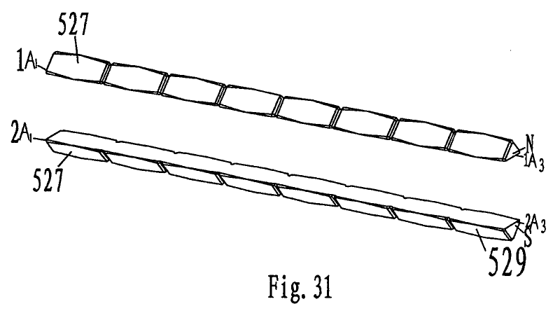

For a masons hammer head 527′ shown in FIG. 28, a masons hammer head blank member 527 having no fitting-hole 546 is designed, each technique indentation 528 is reserved on both sides of the fitting-hole portion of the masons hammer head 527′ in accordance with the deformation amount to occur upon hole punching, the masons hammer head blank members 527 having the technique indentations 528 are combined into a masons hammer head blank member group 529 in accordance with a head-end T to head-end T joined and tail-end W to tail-end W joined arrangement manner as shown in FIG. 30, parting surfaces 1A₁A₃, 2A₁A₃ hand-tool head group are designed along a diagonal section of a cross section of the masons hammer head blank member group 529 as shown in FIG. 31, and in accordance with the same annular cavity manufacture method as that of the second embodiment, the cavities 16 and 17 of the cavity body 503 of the upper roller and the cavity body 563 of the lower roller are formed, the cavity body 503 and the driving gear 501 are assembled onto the roller body 504 to become the upper roller 505, and the cavity body 563 and the driven gear 508 are assembled onto the roller body 564 to become the lower roller 507.

As shown in FIGS. 34, 35, 36 and 37, the upper roller 505 and the lower roller 507 are assembled onto the rolling mill frame 12, the floating gears 510 and 511 are engaged with each other through the coupling plates 533, 539, 537, 530 and the shafts 513, 514, 515 and are engaged with the gears 501, 508 respectively, and thus the gear 501 drives the gear 510, the gear 510 in turn drives the gear 511, and the gear 511 in turn drives the gear 508, so that the upper roller 505 and 507 are rotated in opposite directions. When the two-roller longitudinal cavity alignment is need to be adjusted due to the cavity misalignment, the worm 516 drives the worm wheel 515 to rotate the nut on the worm wheel 515 so as to lengthen the screw 517, the screw 517, through the coupling plates 533, 539, 537, 530 and the shafts 513, 514, 515, causes the two floating gears 510 and 511 to move upward or downward in S or −S direction in normal engagement state, and such movement can cause the annular cavity 16 of the upper roller to rotate an angle with respect to the annular cavity 17 on the lower roller, thereby realizing the adjustment of the two-ring-cavity longitudinal cavity alignment.

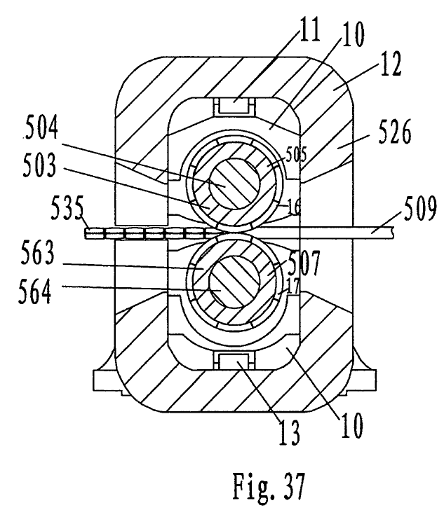

As shown in FIG. 37, a billet 509 is fed into the annular cavities 16 and 17 of both upper and lower rollers to roll out the blank 535 constituted by the end-joined masons hammer head blank members 527, the masons hammer head blank members 527 formed by cutting off the blank 535 are punched to create the fitting-holes by using a hole-punching technology, and since the masons hammer head blank members 527 have the technique indentations 528 reserved at the fitting-hole positions, the expanding action on the hole walls by punch heads upon hole punching will make the technique indentations 528 become flush with the side surfaces of the masons hammer head, so as become the masons hammer head 527′ which conform to standard requirements without trimming its side surfaces.

As shown in FIG. 34, along the circumference of the cavity body 503 there is provided with a concave locating slot 20, into which a part of the cavity body 563 is embedded after the upper and lower rollers are mounted, thereby functioning as a lateral location.

As shown in FIG. 34, on both sides of the annular cavities 16 and 17 there are provided pressure-release slots 2, so as to effectively avoid the mould from cracking.

### Fourth Embodiment

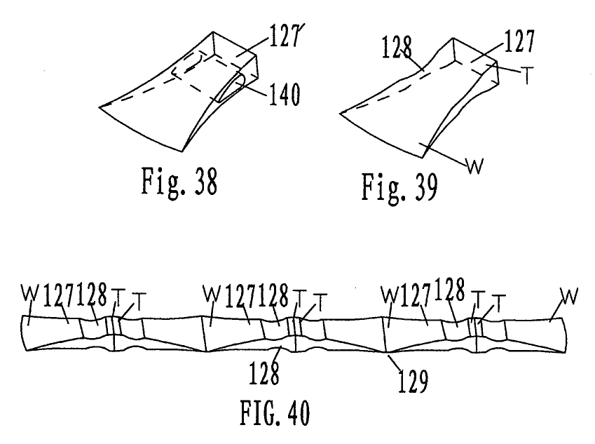

An axe head manufacture method is illustrated as another example of the hand-tool head as shown in FIG. 38.

As shown in FIG. 38, hand-tools, such as axes, pickaxes, etc., will be rolled which have stretching and deforming direction not consistent with the direction of a axe head hole 140, wherein a axe head blank member 127 having no the axe head hole 140 is designed as shown in FIG. 39, each technique indentation 128 is reserved on both sides of a fitting-hole portion of the axe head blank member 127 in accordance with the punching and expanding deformation amount data of the punch head upon hole punching and processing, and the axe head blank member 127 having the technique indentations 128 are combined into a axe head blank member group 129 in accordance with a head-end T to head-end T joined and tail-end W to tail-end W joined arrangement manner as shown in FIG. 40.

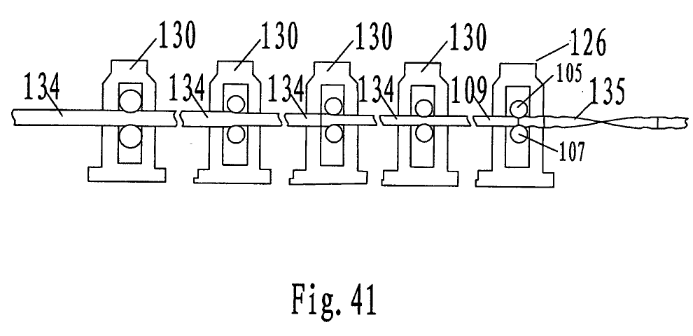

An upper roller 105 and a lower roller 107 are manufactured in accordance with same method as that of the second embodiment, and assembled into a rolling mill 126, by which a blank 135 is rolled out, as shown in FIG. 41, a plurality of conventional steel rolling mills 30 are arranged in series to combine into a continuous heat-rolling apparatus, of course a transverse-arranged reciprocal type continuous heat-rolling apparatus also can be used, a metallurgical rough billet 134, after being divided and initially rolled, is rolled to form a billet 109 which conform to forming and fine rolling technique requirements, and then fine rolling is performed using a continuous forming rolling mill, so that by one time of heating the blank 135 constituted by the joined hand-tool heads can be produced by using the metallurgical rough billet 134, thereby improving the efficiency and reducing the production cost. The blank 135 are cut off to become the axe head blank members 127, which are punched to create the fitting-holes by using a hole-punching technology, and since the rolled axe head blank members 127 have the technique indentations 128 reserved at the handle fitting-hole positions, the expanding action on the hole walls by punch heads upon hole punching will make the technique indentations 128 become flush with the side surfaces of the axe head, so as become the axe head which conform to standard requirements without trimming its external shape.

### Fifth Embodiment

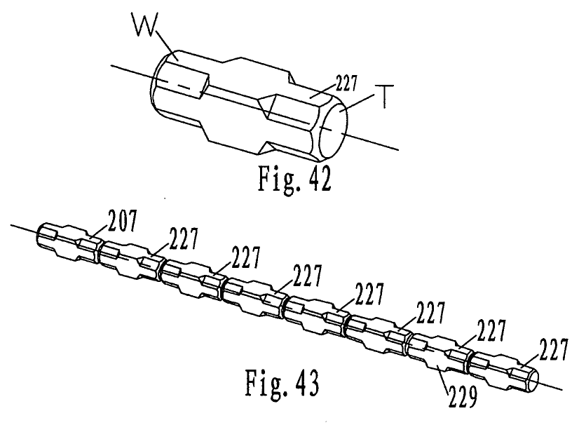

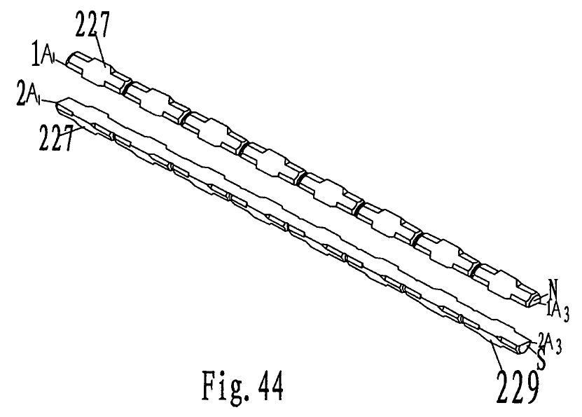

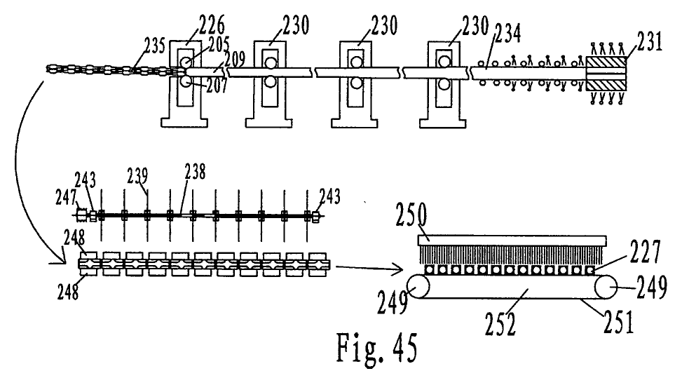

A manufacture method of an octagonal hammer head 227′ is illustrated as another example of the hand-tool head as shown in FIG. 42, and octagonal hammer head blank members 227 are arranged into an octagonal hammer head blank member group 229 shown in FIG. 43, by an end joined manner. As shown in FIG. 44, a parting surface A₁A₃ is designed of the octagonal hammer head blank member group 229 so as to make the parting surface A₁A₃ coincide with a diagonal section of a middle square part of a hammer head body, annular cavities of an upper roller 205 and a lower roller 207 are manufactured in accordance with same method as that of the second embodiment, and are arranged to make eight-edge portions of the octagonal hammer head easily fill the whole cavities, two rollers are assembled into a rolling mill 226, as shown in FIG. 45, a crystallizer 231 and a conventional rolling mill 230 is provided upstream the rolling mill 226, a rough billet 234 is continuously cast, which is fed to the conventional rolling mill 230 and rolled into a billet 209 that conforms to fine rolling technique requirements of the octagonal hammer head, and the billet 209 is rolled into an elongate octagonal hammer head blank member 235 by the rolling mill 226, thereby realizing the continuous casting and rolling.

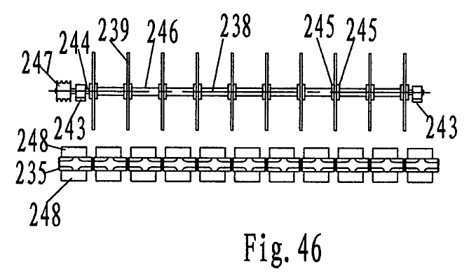

As shown in FIGS. 45 and 46, downstream the rolling mill 226 there is provided with a heat saw device 238, which comprises a saw shaft 244 mounted to two bearing seats 243, ten heat-saw blades 239 that are provided on the saw shaft through holding plates 245 and each have the intervals adjusted by spacers 246 to make their adjacent intervals equal to the length of octagonal hammer head 227′, a pulley 247 provided on the saw shaft, and a positioning and holding device 248, the power drive the saw blades 239 to rotate and cut through the pulley 247 and the saw shaft 244, after the end of the blank 235 is adjusted by the device 248 to make one end of the joined octagonal hammer heads align with one piece of heat-saw blade, the other saw blades will also be precisely aligned with the ends of other joined hand-tool heads, and 10 octagonal hammer head blank members 227 can be cut off while the saw blades 239 are rotated to saw the blank 235 one time.

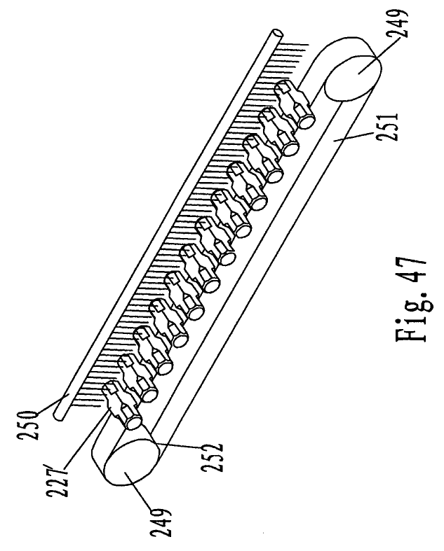

As shown in FIGS. 45 and 47, a residual heat quenching machine tool 252 comprises two machine tool conveyer belt pulleys 249, a quenching conveyer belt 251 and a medium spray head 250, when being quenched the heat-sawed octagonal hammer head blank members 227 are placed onto the quenching conveyer belt 251 driven by the machine tool conveyer belt pulleys 249, the quenching medium blown out by the medium spray head is used to locally cool both end surfaces of the octagonal hammer, and it is assured that the hammer body portion is cooled naturally, so that the hardness of its ends can reach HRC50-58 whereas the hardness of its hammer body does not exceed HRC30, this heat-treatment technique combines organically a deformation strengthening and a phase change strengthening so as to improve substantially mechanical characteristics of the octagonal hammer head, further the cut surfaces of the ends formed by heat-sawing are smooth and clean and no oxidized skins, and when the cut surfaces are locally quenched, the medium uniformly cools all portions of the ends, so that the quenching hardness is uniform, thereby realizing the residual rolling heat quenching of the octagonal hammer heads on a production flow line by using that machine tool.

As shown in FIGS. 45, 46 and 47, the production flow line provided with the crystallizer 231, the conventional rolling mill 230, the rolling mill 226, the heat saw device 238 and the residual heat quenching machine tool realizes the flow line operations from the continuous casting, the continuous rolling, the forming, the automatic heat sawing to quench heat-treating, and this technique has a high efficiency and a low energy consumption and suits for a mass industrial production.

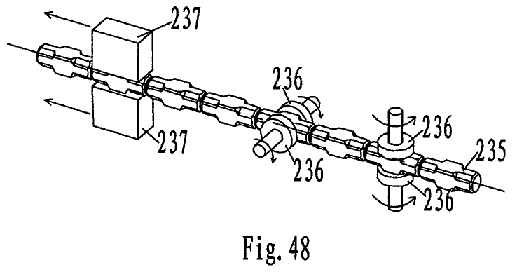

As shown in FIG. 48, a pair of vertical grinding wheels 236 and a pair of horizontal grinding wheels 236 are used to grind the four surfaces of the blank 235, and the automatic feeding is performed by a drive control dragging block 237 of an automatic feeding system, so that the continuously automatic polishing and grinding of the octagonal hammer heads is realized, and the polished and grinded elongate blank 235, after being cut off at the joined ends, becomes the octagonal hammer head blank members 227.

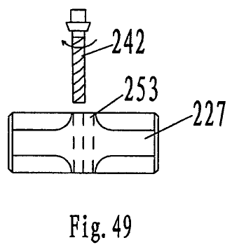

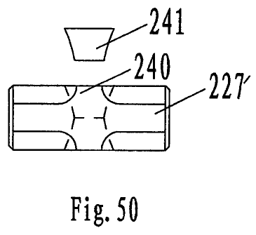

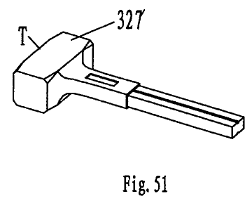

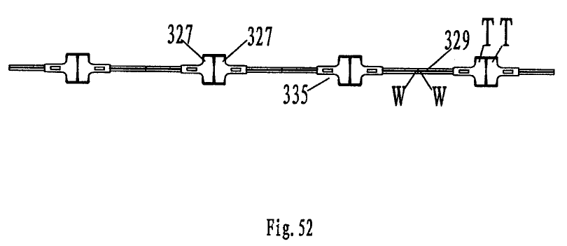

Since the fitting-hole of the octagonal hammer head 227′ is a through hole which has not only a large section but also a great depth, and is difficult to be directly rolled and formed, if the rolled octagonal hammer head blank members are punched to form the fitting-holes after being heated, then the efficiency is low, the energy consumption is large and the quality is instable, so that as shown in FIG. 49, the rolled octagonal hammer head blank members 227 are drilled to form pre-machining holes 253 by using a drilling bit 242, those pre-machining holes 253 remove part of metal of the fitting-holes, and after locating the fitting-holes, are punched into the fitting-holes 240 by a punch head 241 as shown in FIG. 50, and this method greatly reduce the punching tonnage and can form the fitting-holes 240 by a cold punching technique.

### Sixth Embodiment

As shown in FIG. 51, a manufacture method of a masons hammer head 327′ with a handle, as another example of the hand-tool head, is used to illustrate the manufacture method of the hand-tool head of the invention.

First a masons hammer head blank member group 329 is designed constituted by an even number of top-end T to top-end T joined and tail-end W to tail-end W joined hammer heads, an upper roller and a lower roller are formed in accordance with same method as that of the second embodiment, and assembled into a rolling mill, and a blank 335 is rolled out by the rolling mill and cut off at the joined ends to form the masons hammer heads 327′.

1.-39. (canceled)

40. A hand-tool head manufacturing method, characterized by that, by using a rolling mill (26, 126, 226, 526) in which on roller surfaces of an upper roller (5, 105, 205, 505) and a lower roller (7, 107, 207, 507) there are provided concave cavities, a blank (35, 135, 235, 335, 535) constituted by hand-tool head blank members (27, 127, 227, 327, 527) which are joined head-end (T) or tail-end (W) to head-end (T) or tail-end (W) is rolled out, and is cut off at a place in which the head-end (T) or tail-end (W) is joined with head-end (T) or tail-end (W) to form hand-tool heads (27′, 127′, 227′, 327′, 527′), and sections formed after the cut offing at the place in which head-end (T) or tail-end (W) is joined with head-end (T) or tail-end (W) are end faces of the head-end (T) or tail-end (W) of the hand-tool heads (27′, 127′, 227′, 327′, 527′).

41. The hand-tool head manufacturing method according to claim 40, characterized by that, the concave cavities on the roller surfaces of said upper roller (5, 105, 205, 505) and lower roller (7, 107, 207, 507) are concave annular cavities (16) and (17), which have shapes that correspond to that of a hand-tool head group (29, 129, 229, 329, 529) constituted by an integral number of hand-tool head blank members (27, 127, 227, 327, 527) which are joined head-end (T) to head-end (T) and tail-end (W) to tail-end (W), and said blank (35, 135, 235, 335, 535) is a blank constituted by hand-tool head blank members (27, 127, 227, 327, 527) which are joined head-end (T) to head-end (T) and tail-end (W) to tail-end (W).

42. The hand-tool head manufacturing method according to claim 41, characterized by that, the hand-tool head blank members (27, 127, 227, 327, 527) constituting said blank (35, 135, 235, 335, 535) have head-ends (T) which are different from their tail-ends (W), and are arranged in such a manner that the head-ends (T) are joined to the head-end (T) and the tail-ends (W) are joined to the tail-ends (W).

43. The hand-tool head manufacturing method according to claim 40, characterized by that, corresponding to one rolling turn of the upper roller (5, 105, 205, 505) and the lower roller (7, 107, 207, 507) of the rolling mill (26, 126, 226, 526), a hand-tool head blank member group (29, 129, 229, 329, 529) constituted by an integral number of hand-tool head blank members can be rolled, said integral number of hand-tool head blank members being joined at ends.

44. The hand-tool head manufacturing method according to claim 40, characterized by that, the rolling mill (26, 126, 226, 526) is used to roll out the blank (35, 135, 235, 335, 535) constituted by the end-joined hand-tool head blank members (27, 127, 227, 327, 527), the blank (35, 135, 235, 335, 535) is cut off into the hand-tool head blank members (27, 127, 227, 327, 527), and fitting-holes (40, 140, 240, 540) of the hand-tool head blank members (27, 127, 227, 327, 527) are machined to form the hand-tool heads (27′, 127′, 227′, 327′, 527′).

45. The hand-tool head manufacturing method according to claim 44, characterized by that, after a part of metal at the fitting-hole (240) of the hand-tool head (227′) is first removed from the hand-tool head blank member (227) by drilling method, the fitting-hole (240) is punched by a punch head (241).

46. The hand-tool head manufacturing method according to claim 44, characterized by that, the rolling mill (26, 126, 526) is used to roll out the blank (35, 135, 535) constituted by the end-joined hand-tool head blank members (27, 127, 527) in which the locations of the fitting-holes are provided with technique indentations (28, 128, 528), the blank (35, 135, 535) is cut off in accordance with the length of the hand-tool head, and the cut-off hand-tool head blank members (27, 127, 527) are punched at the locations of the fitting-holes by the punch head (241) to form the fitting-holes (40, 140, 540).

47. The hand-tool head manufacturing method according to claim 40, characterized by that, a billet (9, 109, 209, 509) is heated, the rolling mill (26, 126, 226, 526) is used to roll the billet (9, 109, 209, 509) into the blank (35, 135, 235, 335, 535) constituted by the end-joined hand-tool head blank members (27, 127, 227, 327, 527), and the heat-rolled blank (35, 135, 235, 335, 535) is heat-treated using the residual rolling heat.

48. The hand-tool head manufacturing method according to claim 40, characterized by that, a billet (9, 109, 209, 509) is heated, the rolling mill (26, 126, 226, 526) is used to roll the heated billet (9, 109, 209, 509) into the blank (35, 135, 235, 335, 535) constituted by the end-joined hand-tool heads, and after the blank (35, 135, 235, 335, 535) is cut off to form the hand-tool head blank members (27, 127, 227, 327, 527), they are heat-treated using the residual rolling heat.

49. The hand-tool head manufacturing method according to claim 48, characterized by that, the ends of the hand-tool head blank members (27, 127, 227, 327, 527) are quenched using the residual rolling heat.

50. The hand-tool head manufacturing method according to claim 40, characterized by that, the heat-rolled blank (35, 135, 235, 335, 535) is cut off at the joined ends of the hand-tool head blank members (27, 127, 227, 327, 527) using a saw machine, which is provided with several saw-blades at the interval of length of the hand-tool heads (27′, 127′, 227′, 327′, 527′).

51. The hand-tool head manufacturing method according to claim 40 or 41, characterized by that, there is provided a conventional rolling mill (230) upstream the rolling mill (226).

52. The hand-tool head manufacturing method according to claim 40 or 41, characterized by that, there is provided a crystallizer (231) upstream the rolling mill (226).

53. The hand-tool head manufacturing method according to claim 40, characterized by that, the surface of the rolled blank is continuously grinded and polished.

54. The hand-tool head manufacturing method according to claim 41, characterized by that, said hand-tool head is a circular head hammer (27′), and said hand-tool head blank member group is a circular head hammer blank member group (29).

55. The hand-tool head manufacturing method according to claim 41, characterized by that, said hand-tool head is an axe head, and said hand-tool head blank member group is an axe head blank member group (129).

56. The hand-tool head manufacturing method according to claim 40, characterized by that, said hand-tool head is an octagonal hammer head (227′), and said hand-tool head blank member group is an octagonal hammer head blank member group (229).

57. The hand-tool head manufacturing method according to claim 40, characterized by that, said hand-tool head is a masons hammer head (327′), and said hand-tool head blank member group is a masons hammer head blank member group (329).

58. A rolling mill for continuously rolling hand-tool heads, comprising a rolling mill frame (12), an upper roller (5, 105, 205, 505) and a lower roller (7, 107, 207, 507), with concave cavities being formed on the roller surfaces of both the upper roller (5, 105, 205, 505) and the lower roller (7, 107, 207, 507), characterized by that, the concave cavities on the roller surfaces of both the upper roller (5, 105, 205, 505) and the lower roller (7, 107, 207, 507) are concave annular cavities (16) and (17), which have shapes that correspond to that of a hand-tool head blank member group (29, 129, 229, 329, 529) constituted by an integral number of hand-tool head blank members (27, 127, 227, 327, 527) which are joined head-end (T) to head-end (T) and tail-end (W) to tail-end (W).

59. The rolling mill for continuously rolling hand-tool heads according to claim 58, characterized by that, the shapes of said concave annular cavities (16) and (17) correspond to those of the hand-tool head blank member group (29, 129, 229, 329, 529) constituted by an even number of hand-tool head blank members (27, 127, 227, 327, 527), in which the section shape of the head-end (T) is different from that of the tail-end (W) and which are joined head-end (T) to head-end (T) and tail-end (W) to tail-end (W).

60. The rolling mill for continuously rolling hand-tool heads according to claim 59, characterized by that, said concave annular cavities (16, 17) are formed in following manner: designing a parting surface (A₁A₃) of the hand-tool head blank member group (29, 129, 229, 329, 529) in the manner of joining an integral number of hand-tool head blank members (27, 127, 227, 327, 527) head-end (T) to head-end (T) and tail-end (W) to tail-end (W), forming the annular concave cavity (16) along the roller surface of the upper roller (5, 105, 205, 505) in accordance with the shape of the portion of the hand-tool head blank member group (29, 129, 229, 329, 529) on the upper side, i.e. the (N) side, of the parting surface (A₁A₃), and forming the annular concave cavity 17 along the roller surface of the lower roller (7, 107, 207, 507) in accordance with the shape of the portion of the hand-tool head blank member group (29, 129, 229, 329, 529) on the lower side, i.e. the (S) side, of the parting surface (A₁A₃).

61. The rolling mill for continuously rolling hand-tool heads according to claim 59, characterized by that, the upper roller (5, 105, 205, 505) and the lower roller (7, 107, 207, 507) are equipped with a driving gear (1, 501) and a driven gear (8, 508), are mounted to the rolling mill frame (12), and are rotatable in opposite directions while the positions correspond, and when the driving gear (1, 501) and the driven gear (8, 508) are rotated, the annular cavity (16) and the annular cavity (17) correspond to each other to combine into a cavity (19) whose sectional shape is same as that of the hand-tool head blank member group (29, 129, 229, 329, 529) at the corresponding position.

62. The rolling mill for continuously rolling hand-tool heads according to claim 60, characterized by that, forming said concave annular cavities further includes: several cross sections (B₀, B₁, B₂, B₃, Bₙ₋₁, Bₙ) perpendicular to the parting surface (A₁A₃) are formed starting from one end of the hand-tool head blank member group (29, 129, 229, 329, 529), several cross sections (1B₀, 1B₁, 1B₂, 1B₃, . . . 1Bₙ₋₁, 1Bₙ) and (2B₀, 2B₁, 2B₂, 2B₃, . . . 2Bₙ₋₁, 2Bₙ) perpendicular to parting surfaces (1A₁1A₃) and (2A₁2A₃) are respectively formed, starting from intersecting positions of the sections (B₀, B₁, B₂, B₃, . . . Bₙ₋₁, Bₙ) with the parting surface (A₁A₃), on the hand-tool head portion on the upper side, i.e. the (N) side, of the parting surface and the hand-tool head portion on the lower side, i.e. the (S) side, of the parting surface, the parting surface (1A₁1A₃) of the hand-tool heads on the (N) side is bent into a circle (1A₁1A₃′), in such a manner that the parting surface is outside, that the section (1B₀) coincides with the section (1Bₙ), which circle (1A₁1A₃′) coincides with an outside circle of the cavity part of the upper roller (5), and that the various sections (1B₀, 1B₁, 1B₂, 1B₃, . . . 1Bₙ₋₁, 1Bₙ) each lie respectively within a plane which is formed by the roller surface generatrix of the upper roller (5, 105, 205, 505) and the axis (O₁O₁′) of the upper roller (5, 105, 205, 505), those sections become several sections (1B₀′, 1B₁′, 1B₂′, 1B₃′, . . . 1Bₙ₋₁′, 1Bₙ′) which use the axis (O₁O₁′) of the upper roller (5, 105, 205, 505) as the intersection line and the roller surface generatrix of the upper roller (5, 105, 205, 505) as their outside borders and between every two of which an included angle is formed, with the various sections (1B₀′, 1B₁′, 1B₂′, 1B₃′, . . . 1Bₙ₋₁′, 1Bₙ′ ) forming the annular cavity (16) part of the upper roller (5, 105, 205, 505), the parting surface (2A₁2A₃) of the hand-tool heads on the (S) side is bent on the lower roller (7, 107, 207, 507), in a direction opposite to that of the parting surface (1A₁A₃′) on the upper roller (5, 105, 205, 505) into a circle (2A₁2A₃′), in which the section (2B₀) coincides with the section (2Bₙ), in such a manner that the parting surface is on outside and that the various sections (2B₀, 2B₁, 2B₂, 2B₃, . . . 2Bₙ₋₁, 2Bₙ) each lie respectively within a plane which is formed by the roller surface generatrix of the lower roller (7, 107, 207, 507) and the axis (O₂O₂′) of the lower roller (7, 107, 207, 507), those sections become several sections (2B₀′, 2B₁′, 2B₂′, 2B₃′, . . . 2Bₙ₋₁′, 2Bₙ′) which use the axis (O₂O₂′) of the lower roller (7, 107, 207, 507) as the intersection line and the roller surface generatrix of the lower roller (7, 107, 207, 507)as their outside border and are arranged in a direction opposite to that from (1B₀′, 1B₁′, 1B₂′, 1B₃′, . . . to 1Bₙ₋₁′, 1Bₙ′) for the upper roller (5, 105, 205, 505) and between every two of which an included angle is formed, with the various sections (2B₀′, 2B₁′, 2B₂′, 2B₃′, . . . 2Bₙ₋₁′, 2Bₙ′) forming the annular cavity (17) part of the lower roller (7, 107, 207, 507), characterized further by that, when the upper roller (5, 105, 205, 505) and the lower roller (7, 107, 207, 507) on a rolling mill (26, 126, 226, 526) are rotated in opposite directions at corresponding positions to perform rolling formation, i.e. a billet (9, 109, 209, 309, 509) fed through a rolling-in end is continuously squeezed into a cavity (19) combined by both the cavity (16) and the cavity (17), when the section (1B₀′) on the upper roller (5, 105, 205, 505) lies within a plane (O₁O₁′O₂O₂′) formed by axes (O₁O₁′) and (O₂O₂′) of both rollers, (2B₀′) also lies within that plane, and the cavity (19) combined by both the cavity (16) and the cavity (17) at the two sections (1B₀′, 2B₀′) within this plane forms the billet (9, 109, 209, 309, 509) into a shape of the hand-tool head blank member group (29, 129, 229, 329, 529) at the section (B₀). When the section (1B₁′) lies within the plane (O₁O₁′O₂O₂′) formed by axes (O₁O₁′) and (O₂O₂′) of both rollers, (2B₁′) also lies within that plane, the cavity (19) combined by the cavities (16) and (17) at the two sections (1B₁′ and 2B₁′) within the plane (O₁O₁′O₂O₂′) in turn forms the billet (9, 109, 209, 309, 509) into a shape of the hand-tool head blank member group (29, 129, 229, 329, 529) at the section (B₁), in the same manner, when the sections (1B₂′, 1B₃′, . . . 1Bₙ₋₁′, 1Bₙ′) lie within the plane (O₁O₁′O₂O₂′) formed by axes (O₁O₁′) and (O₂O₂′) of both rollers, the sections (2B₂′, 2B₃′, . . . 2Bₙ₋₁′, 2Bₙ′) also lie within the plane (O₁O₁′O₂O₂′) formed by axes of both rollers, the corresponding cavity (19) forms the billet (9, 109, 209, 309, 509) into the shapes of the hand-tool head blank member group (29, 129, 229, 329, 529) at the sections (B₂, B₃, . . . Bₙ₋₁, Bₙ), the rolling movement of the cavity (19) combined by both the cavity (16) and the cavity (17) continuously applies pressure to the billet (9, 109, 209, 309, 509), and the cavity (19) causes the billet (9, 109, 209, 309, 509) to be deformed at the rolling-out end into an elongate blank (35, 135, 235, 335, 535) which has section shapes of (B₀, B₁, B₂, B₃, . . . Bₙ₋₁, Bₙ) and is constituted by the hand-tool head blank member groups (29, 129, 229, 329, 529) which are joined end to end.

63. The rolling mill for continuously rolling hand-tool heads according to claim 61, characterized by that, said driving gear (1) and driven gear (8) are arc cylindrical gears.

64. The rolling mill for continuously rolling hand-tool heads according to claim 61, characterized by that, said driving gear (1) and driven gear (8) are herring-bone gears.

65. The rolling mill for continuously rolling hand-tool heads according to claim 61, characterized by that, said driving gear (1) and driven gear (8) are formed in the following manner: a section of the driving gear (1) on the upper roller (5, 105, 205), and a certain section formed by a generatrix of the roller surface on the roller (5, 105, 205) and its axis (O₁O₁′) lie in a same section, and this same section is set as (1C₀), a section (1C₁) formed by another roller surface generatrix and (O₁O₁′) is created using the axis (O₁O₁′) of the upper roller (5, 105, 205) as the intersection line, starting from (1C₀) and in accordance with the same direction as that from (1B₀′) to (1B₁′) and the included angle between them, a section (1C₂) formed by another roller surface generatrix and (O₁O₁′) is created starting from (1C₀) and in accordance with the same direction as that from (1B₀) to (1B₂′) and the included angle between them, and in same manner several sections (1C₃, 1C₄. . . 1Cₙ₋₁ and 1Cₙ) are created on the driving gear (1), so as to make both the designed driving gear (1) and the designed annular cavity (16) of the roller lie on the same axis (O₁O₁′), to make the intersection lines of each section (1C₀, 1C₁, 1C₂, 1C₃, . . . 1Cₙ₋₁, 1Cₙ) and the intersection lines of each section (1B₀′, 1B₁′, 1B₂′, 1B₃′ . . . 1Bₙ₋₁′, 1Bₙ′) all lie on the axis (O₁O₁′) of the upper roller (5, 105, 205), to make (1C₀ and 1B₀′) lie within a same plane (1D₀), (1C₁) and (1B₁′) in a same plane (1D₁), (1C₂) and (1B₂′) in a same plane (1D₂) . . . (1Cₙ₋₁) and (1Bₙ₋₁′) in a same plane (1Dₙ₋₁), (1Cₙ) and (1Bₙ′) in a same plane (1Dₙ), and to make both sections (1Dₙ) and (1D₀) coincide with each other, the sections (1D₁, 1D₂, 1D₃, . . . 1Dₙ₋₁, 1Dₙ) form the upper roller (5, 105, 205), in which the axis (O₁O₁′) is used as the shaft center, the surface has a tooth profile (22) and the annular cavity (16), and the tooth profile (22) and the annular cavity (16) have accurate position correspondence, when the two designed rollers are placed at the corresponding assembling positions, (1B₀′) on the upper roller (5, 105, 205) and (2B₀′) of the lower roller (7, 107, 207) lie within the same plane (O₁O₁′O₂O₂′) formed by the axes (O₁O₁′) and (O₂O₂′) of the two rollers, at that position a section, which is on the driven gear (8,508) on the lower roller (7, 107, 207) and is in the plane (O₁O₁′O₂O₂′) in which the section (1C₀) of the driving gear (1) of the upper roller (5, 105, 205) lies, is set as (2C₀), so as to make (2B₀′) and (2C₀) of the driven gear (8) lie within the same section (2D₀), thus at this corresponding assembling position, both the section (1D₀) having (1B₀′) and (1C₀) therein and the section (2D₀) having (2B₀′) and (2C₀) therein are within the same plane (O₁O₁′O₂O₂′), a section (2C₁) formed by another roller surface generatrix and (O₂O₂′) is created starting from (2C₀) and in accordance with the same direction as that from (2B₀′) to (2B₁′) and the included angle between them, a section (2C₂) formed by another roller surface generatrix and (O₂O₂′) is created starting from (2C₀) and in accordance with the same direction as that from (2B₀′) to (2B₂′) and the included angle between them, and in same manner several sections (2C₃, 2C₄ . . . 2Cₙ₋₁ and 2Cₙ) are created on the lower roller (7, 107, 207), so as to make the intersection lines of each section (2C₀, 2C₁, 2C₂, 2C₃, . . . 2Cₙ₋₁, 2Cₙ) and the intersection lines of each section (2B₀′, 2B₁′, 2B₂′, 2B₃′ . . . 2Bₙ₋₁′, 2Bₙ′) all lie on the axis of the lower roller (7, 107, 207), to make (2C₀) and (2B₀′) lie within a same plane (2D₀), (2C₁) and (2B₁′) in a same plane (2D₁), (2C₃) and (2B₃′) in a same plane (2D₃), (2Cₙ₋₁) and (2Bₙ₋₁) in a same plane (2Dₙ₋₁), (2Cₙ) and (2Bₙ′) in a same plane (2Dₙ), and to make (2D₀) coincide with (2Dₙ), the sections (2D₀, 2D₁, 2D₂, 2D₃, . . . 2Dₙ₋₁, 2Dₙ) form the lower roller (7, 107, 207), in which the axis (O₂O₂′) is used as the shaft center, its outside circular surface has a tooth profile (23) and the annular cavity (17), and the tooth profile (23) and the annular cavity (17) have accurate position correspondence, when the section (1B₀′) on the upper roller (5, 105, 205) lies within the plane (O₁O₁′O₂O₂′) formed by the axes of the two rollers, the tooth profile (22) of the driving gear (1) engages with the tooth profile (23) of the driven gear (8) to make the section (2B₀′) on the lower roller (7, 107, 207) also lie within that plane, the cavity (19) combined by the cavities (16) and (17) at the two sections (1B₀′ and 2B₀′) within the plane (O₁O₁′O₂O₂′) is able to form the billet (9, 109, 209) into a shape of the hand-tool head blank member group (29) at the section (B₀), when the upper roller (5, 105, 205) is rotated to make the section (1B₁′) lie within the plane (O₁O₁′O₂O₂′) formed by axes of both rollers, the tooth profile (22) of the driving gear (1) drives the tooth profile (23) of the driven gear (8) to be rotated so as to make (2B₁′) on the lower roller (7, 107, 207) also lies within that plane (O₁O₁′O₂O₂′), the cavity (19) combined by the cavities (16) and (17) at the two sections (1B₁′) and (2B₁′) within that plane (O₁O₁′O₂O₂′) in turn forms the billet (9, 109, 209) into a shape of the hand-tool head blank member group (29, 129, 229, 329) at the section (B₁), in the same manner, when the sections (1B₂′, 1B₃′, . . . 1Bₙ₋₁′, 1Bₙ′) lie respectively within the plane (O₁O₁′O₂O₂′) formed by axes of both rollers, the tooth profile (22) of the driving gear (1) engages with the tooth profile (23) of the driven gear (8) to make the sections (2B₂′, 2B₃′, . . . 2Bₙ₋₁′, 2Bₙ′) on the lower roller (7, 107, 207) also lie correspondingly within the plane formed by axes of both rollers, the corresponding cavity (19) forms the billet (9, 109, 209) into shapes of the hand-tool head blank member group (29, 129, 229, 329) at the sections (B₂, B₃, . . . Bₙ₋₁, Bₙ), the rolling movement of the cavity (19) combined by both the cavity (16) and the cavity (17) continuously applies pressure to the billet (9, 109, 209), so as to cause the billet (9, 109, 209) to be deformed at the rolling-out end into an elongate blank (35, 135, 235, 335) which has section shapes of (B₀, B₁, B₂, B₃, . . . Bₙ₋₁, Bₙ (B₀)), (B₁, B₂, B₃, . . . Bₙ₋₁, Bₙ (B₀)) and is constituted by the hand-tool head blank member groups (29, 129, 229, 329) which are joined end to end.

66. The rolling mill for continuously rolling hand-tool heads according to claim 59, characterized by that, on both sides of the annular cavity of the roller on said rolling mill (26, 126, 226, 526) there are provided pressure-release slots 2.

67. The rolling mill for continuously rolling hand-tool heads according to claim 59, characterized by that, along the circumference of the upper roller (5, 105, 205, 505) of said rolling mill (26, 126, 226, 526) provided is a concave locating slot (20), into which a part of the lower roller (7, 107, 207, 507) is embedded after being mounted.

68. The rolling mill for continuously rolling hand-tool heads according to claim 59, characterized by that, in blank-withdraw cam fitting-holes (21) of the rollers there are provided blank-withdraw cams (25).

69. The rolling mill for continuously rolling hand-tool heads according to claim 59, characterized by that, in cavities of the cavity (17) on the rollers there are provided blank-withdraw rods (24).

70. The rolling mill for continuously rolling hand-tool heads according to claim 59, characterized by that, said hand-tool head is an octagonal hammer head (227′), said hand-tool head blank member group (229) is an octagonal hammer head blank member group, and the longitudinal designed parting-surface (A₁A₃) of said octagonal hammer head blank member group (229) coincides with the diagonal section of the middle square portion of the octagonal hammer body.

71. The rolling mill for continuously rolling hand-tool heads according to claim 58, characterized by that, the upper roller (5, 105, 205, 505) and the lower roller (7, 107, 207, 507) are formed by embedding cavity bodies (3) onto roller bodies (4).

72. The rolling mill for continuously rolling hand-tool heads according to claim 58, characterized by that, said upper roller (505) is connected with a driving gear (501), the lower roller (507) is connected with a driven gear (508), the driving gear (501) drives the driven gear (508) through a floating gear (510) and a floating gear (511), and the upward and downward movement of the floating gear (510) and the floating gear (511) can cause the annular cavity (16) on the upper roller (505) to rotate an angle with respect to the annular cavity (17) on the lower roller (507).

73. A dedicated rolling mill for continuously rolling an irregularly shaped section for an axe head or a hammer head, comprising a rolling mill frame and a plurality of groups of rollers, each of said groups of rollers including an upper roller, a lower roller, a driving gear and a driven gear, said driving gear being fixed on the upper roller, the driven gear being fixed on the lower roller, the upper roller and the lower roller having the same diameter, the driving gear and the driven gear being same in tooth number, the driving gear being engaged with the driven gear, on the arc surfaces of the upper roller and the lower roller there being provided continuous cavities which are concave and constantly unchanged, characterized by that, on the upper roller and the lower roller of the last stage of roller group among said plurality of groups of rollers there are provided cavities which are concave and have changes in their section shape and section area, and the upper roller and the lower roller correspond to each other and are combined into continuous axe head shaped cavities or hammer head shaped cavities.

74. The dedicated rolling mill for continuously rolling an irregularly shaped section for an axe head or a hammer head according to claim 73, characterized by that, on both sides of the concave and continuous axe head or hammer head shaped cavities on the arc surfaces of the upper roller and the lower roller of said last stage of roller group, there are provided pressure-release slots respectively.

75. The dedicated rolling mill for continuously rolling an irregularly shaped section for an axe head or a hammer head according to claim 74, characterized by that, on the inside surfaces of said pressure-release slots there are provided strengthening arcs.

76. The dedicated rolling mill for continuously rolling an irregularly shaped section for an axe head or a hammer head according to claim 73, characterized by that, the cavity-to-cavity gap of the upper roller and the lower roller of said last stage of roller group can be 1-3 mm.

77. The dedicated rolling mill for continuously rolling an axe head or a hammer head according to claim 73, characterized by that, the continuous axe head shaped cavities or hammer head shaped cavities combined by the corresponding upper roller and lower roller of said last stage of roller group among said plurality of groups of rollers is arranged in pairs with the head shaped cavities or hammer shaped cavities being joined head to head and tail to tail.

78. The dedicated rolling mill for continuously rolling an axe head or a hammer head according to claim 73, characterized by that, in said last stage of roller group within the rolling mill frame of said rolling mill, above the upper roller there are provided a roller support seat and an upper support and under the lower roller there are provided a roller support seat and a lower support.
